(19) United States
(12) Patent Application Publication
(10) Pub. No.: US 2011/0055471 A1
(43) Pub. Date: Mar. 3, 2011

(54) APPARATUS, SYSTEM, AND METHOD FOR IMPROVED DATA DEDUPLICATION

(76) Inventors: Jonathan Thatcher, Liberty Lake, WA (US); David Flynn, Sandy, UT (US); John Strasser, Syracuse, UT (US)

(21) Appl. No.: 12/550,260

(22) Filed: Aug. 28, 2009

(51) Int. Cl. G06F 12/00

(52) U.S. Cl. 711/114; 711/216; 711/E12.001

(57) ABSTRACT

An apparatus, system, and method are disclosed for improved deduplication. The apparatus includes an input module, a hash module, and a transmission module that are implemented in a nonvolatile storage device. The input module receives hash requests from requesting entities that may be internal or external to the nonvolatile storage device; the hash requests include a data unit identifier that identifies the data unit for which the hash is requested. The hash module generates a hash for the data unit using a hash function. The hash is generated using the computing resources of the nonvolatile storage device. The transmission module sends the hash to a receiving entity when the input module receives the hash request. A deduplication agent uses the hash to determine whether or not the data unit is a duplicate of a data unit already stored in the storage system that includes the nonvolatile storage device.

### BACKGROUND OF THE INVENTION

1. Field of the Invention

This invention relates to data deduplication. In particular, it relates to the timing of deduplication operations and the generation of a hash for such operations.

2. Description of the Related Art

Data deduplication refers generally to the elimination of redundant data in a storage system. Data deduplication can provide considerable benefits in any system, but is particularly valuable in a large enterprise-type storage system. For example, if a large file is sent to multiple individuals in a company as an attachment to an email, it is inefficient use of storage space to store one copy of the large file for each person who received the email. It is better to store a single copy of the file and have pointers direct all recipients to that single copy. Removing redundant data from a system (whether that system is a single drive, a storage area network (“SAN”), network attached storage (“NAS”), or other storage system) provides a number of benefits for a user.

There are generally two current approaches to deduplication. One approach, shown in FIG. 1A, is synchronous, or real-time, deduplication. In synchronous deduplication, a file is typically deduplicated before it is moved onto storage 120. For example, the file may be read into random access memory (“RAM”) 112 of a file server 108 and a deduplication agent 110 generates a hash for the file before the file is stored in storage 120. The deduplication agent 110 searches a hash table 114 for the hash of the file to determine whether or not the file is a duplicate of something already stored in storage 120. If the hash is not found in the hash table 114, the file is not a duplicate. The hash is stored in the hash table 114 and the file is moved out of RAM 112 and into storage 120. If the hash is found in the hash table 114, the file is a duplicate. The deduplication agent 110 updates an index 116 to associate the file sent by the client with the identical file already stored in storage 120. Because it is a duplicate, the file is not moved into storage 120. Future requests for the file are directed to the existing copy of the file by the updated index 116.

FIG. 1B shows asynchronous, or delayed, deduplication. In asynchronous deduplication, the file is generally moved into storage 120 without performing deduplication. At a later time, the deduplication agent 110 requests the file from storage 120, generates a hash, and determines if the file is a duplicate in a manner similar to that described in connection with FIG. 1A. If the file is a duplicate, the index 116 is updated and the file is generally deleted from storage 120. In this manner, deduplication can occur as a background process on the client 208.

Both synchronous deduplication and asynchronous deduplication impose penalties on a system. Both approaches require that the deduplication agent 110 touch the data; that is, the deduplication agent 110 must make a copy or a near copy of the data in order to deduplicate the data. In some instances, it may be desirable to perform deduplication operations at a time other than upon writing a file to storage 120, as occurs in synchronous deduplication. Asynchronous deduplication unnecessarily increases traffic on the bus or network connecting the file server 108 and the storage 120 since the file is first written to storage 120 and then must be read out of storage 120 to generate the hash and perform deduplication. In addition, asynchronous deduplication may make the storage 120 unavailable while the file is being read out, even when more urgent processes require access to storage 120.

### SUMMARY OF THE INVENTION

The apparatus for improved deduplication includes an input module, a hash module, and a transmission module. These modules may be software stored in computer-readable storage media, hardware circuits, or a combination of the two. The invention enables generation of hashes by the storage devices themselves, which hashes can be passed between separate devices, or within the same device, in support of deduplication operations. The input module is implemented on a nonvolatile storage device and receives a hash request from a requesting entity. The input module may be implemented as software stored in memory on the nonvolatile storage device, as a physical device situated within the nonvolatile storage device, as firmware, or by other approaches to implementing modules.

The requesting entity may be, for example, a deduplication agent located remotely from the nonvolatile storage device, a deduplication agent located on the nonvolatile storage device, or another entity. The hash request includes a data unit identifier that identifies the data unit for which the hash is requested. The data unit identifier may be a label such as a filename, object ID, an i-node, or other data unit label. The data unit identifier may also be a data structure (such as a linked list) that includes data unit locations (such as LBAs or physical addresses such as PBAs) that specify the direct or indirect locations on the nonvolatile storage device where the data unit is stored.

The apparatus also includes a hash module implemented on the nonvolatile storage device that executes a hash function for the data unit to generate the hash for the data unit identified by the data unit identifier. This hash identifies the data unit such that the deduplication agent can determine, using the hash, whether a duplicate of the data unit exists in the storage system that includes the nonvolatile storage device. A transmission module is implemented on the nonvolatile storage device and sends the hash to a receiving entity in response to the input module receiving the hash request.

In certain embodiments, the transmission module sends the hash to the receiving entity, but does not send the data unit itself. The hash may be generated when the input module receives the hash request; in other embodiments, the hash is generated at a time prior to, or subsequent to, the input module receiving the hash request. The hash request may be sent as part of a request to write the data unit, and the hash itself may be sent by the transmission module as part of an acknowledgement that the data unit has been successfully written to the nonvolatile storage device.

In certain embodiments, the nonvolatile storage device is part of a redundant array of independent drives (“RAID”—also known as a redundant array of inexpensive disks and redundant array of independent disks) system made up of a plurality of nonvolatile storage devices. In such embodiments, the data unit may be a data segment of a RAID data stripe. In such embodiments, the apparatus may include a seed module that receives a seed to be used in generating the hash and that provides the seed to the hash module. The hash module then uses the seed, in conjunction with the relevant data, to generate the hash.

The seed may itself be the hash of another data unit. For example, the seed may be the hash of a first data segment. The transmission module may send the hash of the first data segment to a second nonvolatile storage device that contains the second data segment and indicate that the hash of the first data segment is to be used as a seed. The hash module of the second nonvolatile storage device may then use the hash of the first data unit as a seed to generate the hash of the second data segment, at which point the transmission module of the second nonvolatile storage device may send the new hash to a third nonvolatile storage device, and so on.

In certain embodiments, the nonvolatile storage device may be a parity-mirror device, as described below. The parity-mirror device may store each data segment of the RAID data stripe locally and generate the hash of the entire RAID data stripe using the locally stored data segments. The hash generation operation may be executed in conjunction with an operation to generate a parity segment for the RAID data stripe.

In certain embodiments, the requesting entity that sends the hash request may do so in response to determining that the data unit is moving down in a cache. The requesting entity may also send the hash request if it determines that the data unit is the subject of a data grooming operation, and that the data unit has not yet been the subject of a deduplication operation. For example, the data grooming operation may be a garbage collection operation or a defragmentation operation.

Also disclosed is a computer program product stored on a computer readable storage medium, which computer program product includes computer usable program code that, when executed, performs operations for improved deduplication. The operations include identifying a data unit to be deduplicated and sending a hash request, along with a data unit identifier for the data unit, to one or more nonvolatile storage devices that store the data unit. The operations may also include receiving the hash from the nonvolatile storage devices that generated the hash for the identified data unit. The operations further include determining whether or not the data unit is a duplicate of an existing data unit stored in the storage system. The hash is used to make this determination.

The operations may further include sending a request to delete either the data unit or the existing data unit if it is determined that the new data unit is a duplicate of the existing data unit. In certain embodiments, the deduplication agent may determine that there are multiple duplicates within the storage system. The operations also include associating the data unit with the existing data unit if the two are duplicates. As a result, requests for the data unit that has been deleted to prevent unnecessary duplication of data are intercepted and sent to the data unit that was kept in the system. In certain embodiments pointers are used to perform the redirection.

The computer program product may be part of a file system operating on a computer system that includes a processor and memory and that is separate from, but connected to, the nonvolatile storage device. The computer program product may be a deduplication agent operating on such a computer, and may receive the hashes over the communications connection (such as a bus or a network) connecting the computer and the nonvolatile storage device, without also receiving the data units themselves. Thus, there is no need to pass the data unit itself to the deduplication agent to generate the hash—the hash may be transmitted independent of the data unit. The deduplication agent may further receive a hash of a data unit, designate it a seed for another data unit, and send the hash to be used as a seed to another nonvolatile storage device storing that data unit.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1, made up of FIGS. 1A and 1B, are schematic block diagrams illustrating prior art approaches to deduplication.

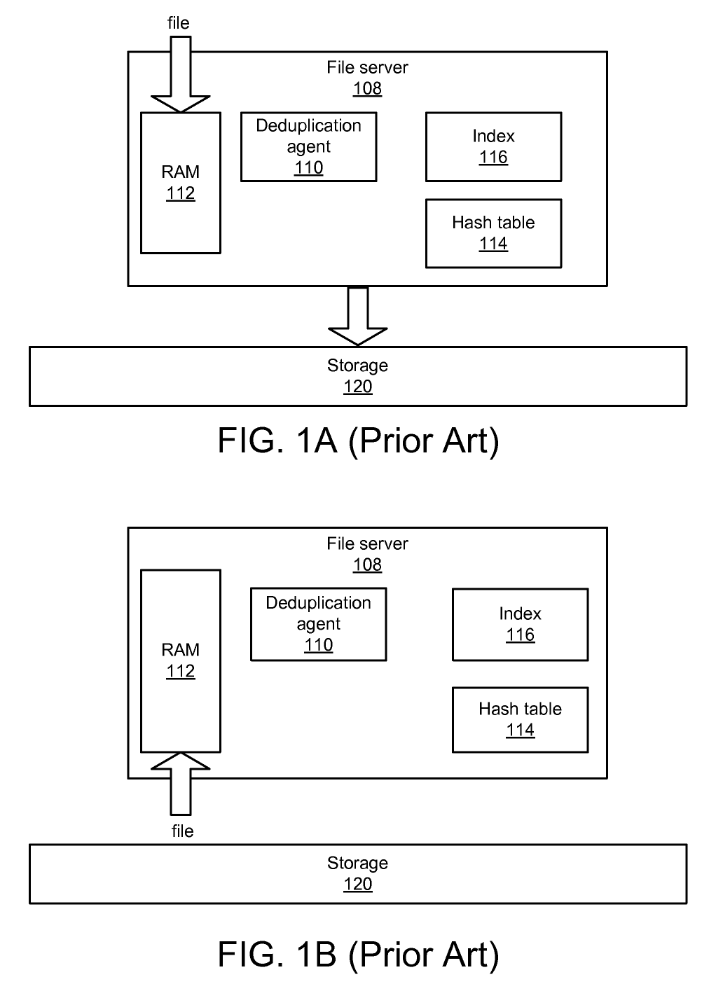

FIG. 2, made up of FIGS. 2A and 2B, are schematic block diagrams illustrating an approach to deduplication.

FIG. 3 is a schematic block diagram illustrating one embodiment of a system for improved deduplication.

FIG. 4 is a schematic block diagram illustrating one embodiment of a system for improved deduplication in a RAID environment.

FIG. 5 is a second schematic block diagram illustrating one embodiment of a system for improved deduplication in a RAID environment.

FIG. 6 is a third schematic block diagram illustrating one embodiment of a system for improved deduplication in a RAID environment.

FIG. 7 is a schematic block diagram of a nonvolatile storage device configured to generate a hash.

FIG. 8 is a schematic block diagram illustrating one embodiment of a system for improved deduplication with the nonvolatile storage device used as a cache.

FIG. 9 is a schematic block diagram illustrating an architecture in which improved deduplication may occur.

FIG. 10 is a second schematic block diagram illustrating an architecture in which improved deduplication may occur.

FIG. 11 is a schematic block diagram illustrating one embodiment of a deduplication agent.

FIG. 12 is a schematic block diagram illustrating a system with separate data and control paths in which improved deduplication may occur.

FIG. 13 is a schematic flow chart diagram illustrating one embodiment of a method for using a hash generated in a nonvolatile storage device for deduplication.

FIG. 14 is a schematic flow chart diagram illustrating one embodiment of a system for performing deduplication in which the hash is generated in the nonvolatile storage device.

FIG. 15 is a schematic block diagram illustrating one embodiment of a system including a deduplication agent in which the hash is generated remotely from the deduplication agent.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented as software, stored on computer readable storage media, for execution by various types of processors. Modules may also be implemented in firmware in certain embodiments. An identified module of executable code may, for instance, comprise one or more physical or logical blocks of computer instructions stored on computer readable storage media which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. Where a module or portions of a module are implemented in software, the software portions are stored on one or more computer readable storage media.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable storage medium may take any physical form capable of storing machine-readable instructions for a digital processing apparatus. A computer readable medium may be embodied by a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs need not strictly adhere to the order of the corresponding steps shown.

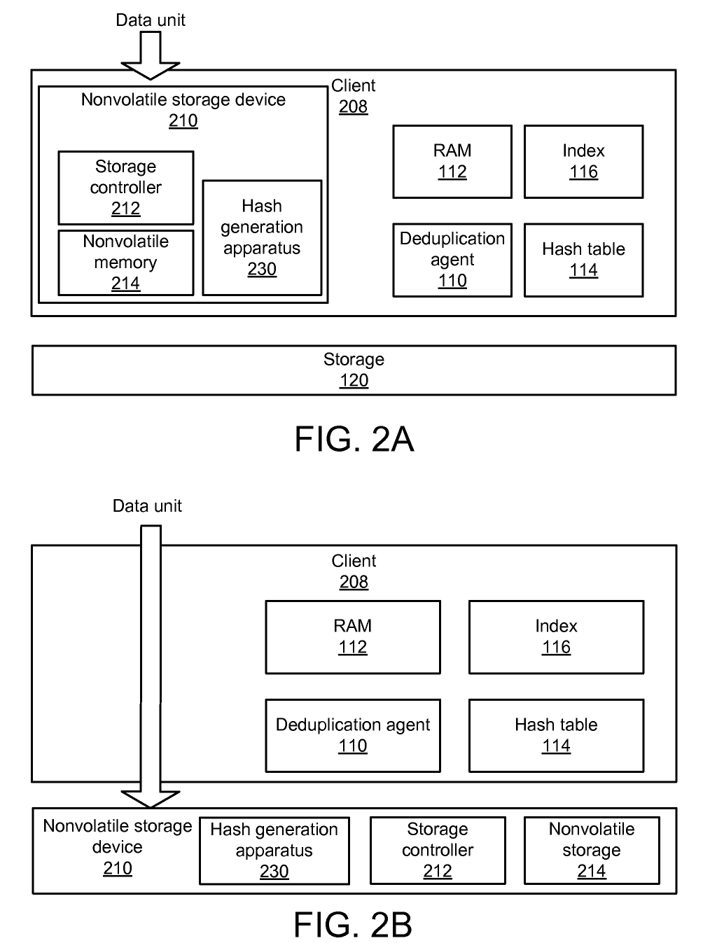

FIG. 2a is a schematic block diagram showing one embodiment of an improved approach to performing deduplication. FIG. 2 includes a client 208 and storage 120. The client 208, in certain embodiments, includes nonvolatile storage device 210, RAM 112, a deduplication agent 110, an index 116, and a hash table 114.

The client 208 is the client of the storage 120. The client 208 sends various actions for execution by the storage 120; for example, the client 208 may send read requests, write requests, and modify requests to the storage 120. In one embodiment, the client 208 is a file server and coordinates the storage and retrieval of data units in the storage 120. The client 208 may be part of an operating system, or may be separate from the operating system. In embodiments where the client 208 is a file server, the client 208 receives requests to store and read data units from other entities (such as applications or operating systems, which may be implemented on the same computing device as the file server or on remotely connected computing devices) and coordinates execution of those requests on the storage 120. The client 208 may be a server that allows other remotely connected computer devices connected to the server by a network to store and retrieve data units from the storage 120.

A data unit, as used in this application, is any set of data that is logically grouped together. A data unit may be a file, an object, a data segment of a RAID data stripe, or other data set used in data storage. The data unit may be executable code, data, metadata, a combination thereof, or any other type of data that may be stored in a memory device. The data unit may be identified by a name, by a logical address, a physical address, an address range, or other convention for identifying data units.

The client 208 is connected to the storage 120 by a communications connection. The communications connection enables data units to be communicated between the client 208 and the storage 120. The communications connection may, in certain embodiments, be a bus and communications on the bus may occur according to a bus protocol such as universal serial bus (“USB”), peripheral component interconnect (“PCI”), PCI express (“PCIe”), HyperTransport (HT), FireWire, Serial ATA, or others. The communications connection may also be a network and communications on the network may occur according to a network protocol such as Infiniband, HyperTransport, Ethernet, Fibre channel, PCI, or others. The client 208 may be similarly connected to the nonvolatile storage device 210.

The client 208 writes data units into the nonvolatile storage device 210. The nonvolatile storage device 210 may include a storage controller 212, a nonvolatile storage 214, and a hash generation apparatus 230. The storage controller 212 manages the storage and retrieval of data units in the nonvolatile storage 214. The storage controller 210 provides functions to support operations of the nonvolatile storage 214 and operations on data units stored therein. For example, the storage controller 210 may decode commands sent to the nonvolatile storage device 210, execute programming and erase algorithms, control analog circuitry (such as enabling and disabling voltage generators and determining the duration of voltage pulses), along with other functions.

The storage controller 212 is connected to the nonvolatile storage 214 by a communications connection (such as a bus) that is typically separate from the communications connection connecting the nonvolatile storage device 210 to external devices such as the client 208, and to additional nonvolatile storage devices. The hash generation apparatus 230 may be part of the storage controller 212, or may be a separate component connected to the storage controller 212 and/or nonvolatile storage 214 by a communications connection that is separate from the communications connection connecting the nonvolatile storage device 210 to external devices.

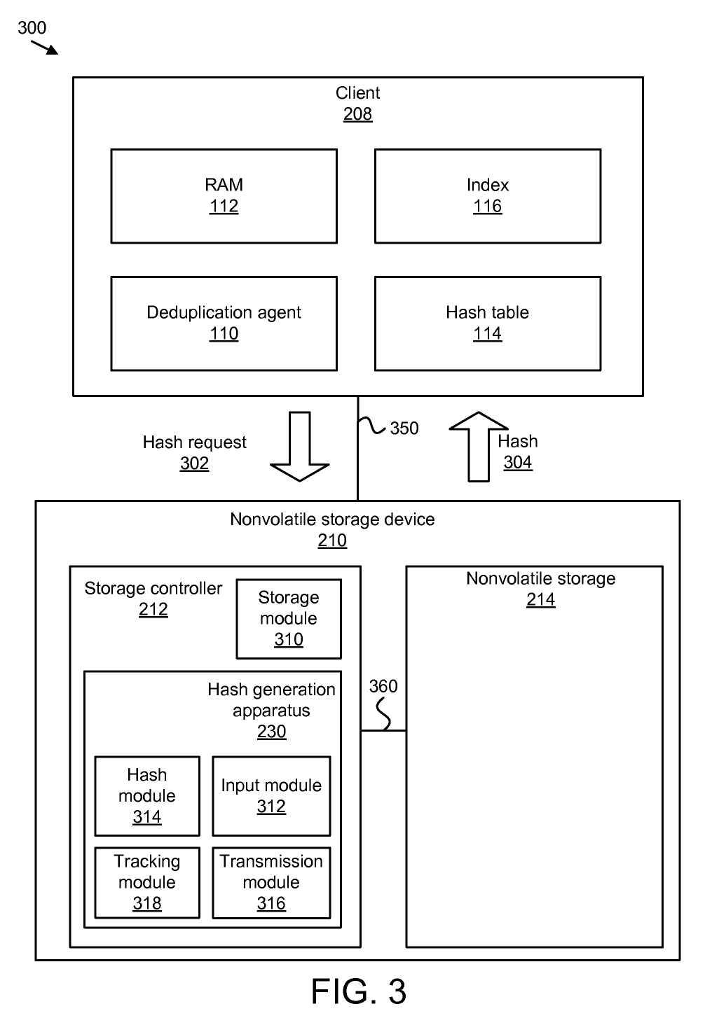

In certain embodiments, the storage controller 212, nonvolatile storage 214, the hash generation module 230, and the communications connection between them are located within a physical form factor. Because the storage controller 212 and the nonvolatile storage 214 communicate over this communications connection (which maybe referred to as a first communications connection and which is illustrated in FIG. 3 as communications connection 360), the storage controller 212, the nonvolatile storage 214, and the hash generation apparatus 230 may share information without adding traffic to the communications connection that connects the storage 120 to other devices such as the client 208 and without adding traffic to the communications connection that connects the nonvolatile storage device 210 and the client 208 (which may be referred to as a second communications connection and which is illustrated in FIG. 3 as communications connection 350).

In addition, the complete system may include additional devices that communicate with the client 208; for example, the client 208 may be a storage manager that coordinates storing data for one or more computing devices connected to the storage manager by a network or a bus. The storage controller 212, nonvolatile storage 214, and the hash generation apparatus 230 may share information without adding traffic to the communications connection that connects the storage manager (the client 208) and the other computing devices.

In FIG. 2, as in other figures in the application, there may be additional components than those shown. For example, there may be multiple clients 208, multiple storage 120, multiple nonvolatile storage devices 210, and other duplication. In many embodiments, the relevant systems will provide redundancy such that failures of one device do not cause a failure of the system. While the figures may show only one of the various components in the system, in typical embodiments redundant components are provided.

The nonvolatile storage device 210 retains data units in nonvolatile storage 214 even if power is not being supplied to the nonvolatile storage device 210. In one embodiment, the nonvolatile storage device 210 is a hard disk drive. In other embodiments, the nonvolatile storage is solid state storage such as Flash, phase-change memory (PRAM), Ferroelectric RAM (FRAM), or other existing or forthcoming solid state storage types. In one embodiment, the nonvolatile storage device 210 is a nonvolatile storage device as described in U.S. application Ser. No. 11/952,091, filed Dec. 6, 2007, by David Flynn, Bert Lagerstedt, John Strasser, Jonathan Thatcher, and Michael Zappe entitled “Apparatus, System, and Method for Managing Data Using a Data Pipeline”, which application is hereby incorporated by reference in its entirety. In particular, the nonvolatile storage device 210 may include a write data pipeline and a read data pipeline as described in paragraphs 122 to 161.

The storage 120 is nonvolatile storage for holding data. The storage 120 may be solid state storage, one or more hard disk drives, tape, some other nonvolatile data storage medium, or a combination of the preceding examples. The capacity of the storage 120 may vary from implementation to implementation. In certain embodiments, such as that shown in FIG. 2A, the storage 120 may be in addition to the nonvolatile storage device 210. For example, the storage 120 may be a backing store implemented using tape, hard disks, etc. In other embodiments, such as that shown in FIG. 2B, the nonvolatile storage device 210 may be the storage 120. The storage 120 may be connected to the client 208 by a bus (such as PCIe, serial ATA, 1394 “FireWire” bus, Infiniband, or the like) and may be internal or external to the hardware supporting the client 208. In certain embodiments, the storage 120 may be network attached storage (NAS), a storage area network (SAN), or other storage solution.

The nonvolatile storage device 210 may also include a hash generation apparatus 230 that generates the hashes for the data units stored in the nonvolatile storage device 210. In certain embodiments, the hash generation apparatus 230 maybe implemented as hardware that connects into the nonvolatile storage device 210. In other embodiments, the hash generation apparatus 230 is implemented as part of the storage controller 212; for example, the hash generation apparatus 230 may be implemented as software or firmware executing on the storage controller 212.

In one embodiment, the deduplication agent 110, operating on the client 208, sends a hash request, which is a request for the hash of a data unit in the nonvolatile storage device 210, to the nonvolatile storage device 210 using the communications connection between the two. The data unit may already be stored in the nonvolatile storage device 210 at the time the hash request is received, sent with the hash request, or sent after the hash request is received. The hash generation apparatus 230 generates the hash for the specified data unit. The hash generation apparatus 230 may read the data unit for which the hash is requested out of the nonvolatile storage 214 and generate the hash for the data unit. The hash generation apparatus 230 may have access to volatile memory, such as RAM (which may be RAM 112 in the client or may be additional RAM within the nonvolatile storage device 210), in which the data unit is held while the storage controller 212 generates the hash.

The hash generation apparatus 230 accesses the data unit and generates the hash for the data unit without unduly burdening the communications connection connecting the nonvolatile storage device 210 and the client 208. Not unduly burdening the communications connection means that the data that is meant to be deduplicated need not be sent over the communications connection connecting the nonvolatile storage device 120 and the client 208 in order to generate a hash. Other data may be transferred over the communications connection (such as control messages and the generated hash); however, the amount of data moving over the communications connection is less than it would be if the data unit itself had to be moved. Since the deduplication agent 110 does not need to touch the data in order to generate the hash for the data unit, the data unit does not need to be transferred over the communications connection between the nonvolatile storage device 210 and the client 208; instead, the hash generation apparatus 230 can generate the hash and send only the hash over the communications connection to the deduplication agent 110. Similarly, the data unit does not need to be transferred over a communications connection between the client 208 and one or more additional computing devices that wish to store or access data; for example, when the client 208 is a storage manager as discussed above. The deduplication agent 110 may then determines whether the particular data unit is a duplicate using the hash. The deduplication agent 110 may make appropriate updates to the index 116 as needed using the hash provided by the nonvolatile storage device 210.

In one embodiment, the deduplication agent 110 receives the hash from the nonvolatile storage device 210 and compares the hash with hashes stored in the hash table 114. If the hash is found in the hash table, the deduplication agent 110 may instruct the nonvolatile storage device 210 to remove the data unit and updates the index 116 appropriately. In other embodiments, the deduplication agent 110 may cause the nonvolatile storage device 210 to store the new data unit, delete the older duplicate data unit, and make appropriate changes to the index 116. If the hash is not found in the hash table 114, the deduplication agent 110 may add the hash to the hash table 114. The particular use of hash table 114 and index 116 described above is simply one example of an approach for deduplication.

The hash is data that is generated using the data unit itself or data derived from the data unit (such as parity data, DIF, or other data) and that identifies the data unit such that it can be determined whether or not the data unit is a duplicate using the hash. The hash may also include metadata for the data unit to help determine whether or not the data unit is a duplicate. In one embodiment, the hash includes the length of the data unit, and the deduplication agent 110 may use the length in determining whether or not the data unit is a duplicate of an existing data unit. In one embodiment, hash may include the data unit type; for example, if a data unit is a file with a type of .jpg, and another data unit is a file with a type of .exe, it is unlikely that the two are duplicates.

The hash for the data unit may be the product of a Message Digest Algorithm 5 (MD5), Secure Hash Algorithms (SHA-1, SHA-2), error correcting code, fingerprints, or other algorithm that can be used to generate data suitable for use as a hash. The hash may also be, for example, a data integrity field (DIF) and used both to check for unwanted data duplication in the system and in order to ensure data integrity. The hash may be a cyclic redundancy check (CRC), a checksum, data used by a database or communications channel for checking data continuity, non-tampering, correct decryption, or other purpose. In certain embodiments, the hash for the data unit may be generated by hashing the data unit DIF. In other embodiments, the hash for the data unit is generated by hashing the data unit segments in a RAIDed environment. In other embodiments, the hash for the data unit may be generated by hashing the parity of the data unit in a RAIDed environment.

Generating the hash in the nonvolatile storage device 210 and passing only the hash may free resources on the client 208 (such as RAM 112, processor cycles, and other resources) and may reduce traffic on the communications connection between the nonvolatile storage device 210 and the host computing device (such as the client 208) having the deduplication agent 110. In certain embodiments, the nonvolatile storage device 210 can interrupt the process of generating the hash for a data unit to perform other operations, such as reading and writing data units out of the nonvolatile storage 214. The nonvolatile storage device 210 may store the intermediate results of the hash generation and continue with the process once the higher priority operation is complete. Thus, the deduplication process need not make the nonvolatile storage device 210 inaccessible to higher priority operations while the nonvolatile storage device 210 is generating the hash. In certain embodiments, if the data unit is updated during the hash generation routine, the hash generation routine may be terminated, postponed, or rescheduled. The hash generation may thus be independent of data unit access. In certain embodiments, the nonvolatile storage device 210 may pass the hash along with the data unit for which the hash was requested.

In certain embodiments, the nonvolatile storage device 210 may receive the hash request from the deduplication agent 110 and flag that particular data unit such that the hash is generated at a later time. In such an embodiment, the nonvolatile storage device 210 may wait until it determines that it is an opportune time to generate and send the hash. For example, the hash generation apparatus 320, operating on the nonvolatile storage device 210, may generate the hash as part of a data grooming operation (such as garbage collection or deduplication), as part of a read operation on the data unit, or other operation.

While FIG. 2 discusses generation of the hash in nonvolatile storage device 210 and passing that hash to a deduplication agent 110 for use in a deduplication process, the hash generated by the nonvolatile storage device 210 may also be used for other purposes. Other processes may similarly benefit from having a hash of a data unit generated in the nonvolatile storage device 210, which hash is then passed on to another device such as the client 208. For example, as noted above, the hash may also serve as a DIF, CFC, checksum, or other function. The system may gain additional performance benefits by having DIFs, CFCs, and checksums generated in the manner described in this application.

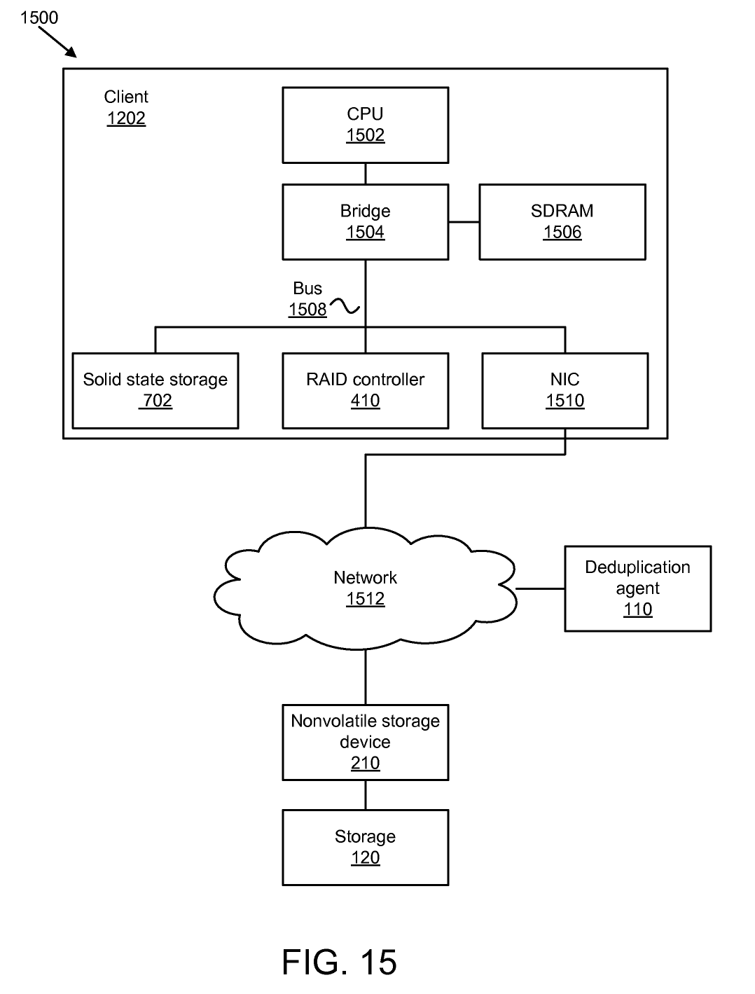

In addition, while FIG. 2 shows and discusses the hash generation apparatus 230 as being located on the nonvolatile storage device 210, in certain embodiments the hash generation apparatus 230 may be located elsewhere in the storage system. For example, the hash generation apparatus 230 may be implemented on a computing device remotely connected to the client 208 that hosts the deduplication agent 110, on a network device, or at another location. Alternative placements for the hash generation apparatus 230 are discussed in greater detail in connection with FIG. 15.

FIG. 3 shows one embodiment of a system 300 for improved deduplication. The system 300 is simply one example of a system configuration that is possible and within the scope of the present invention. The system 300 includes a client 208 and nonvolatile storage device 210. In certain embodiments, the client 208 includes RAM 112, a deduplication agent 110, an index 116, and a hash table 114. The client 208, in one embodiment, acts as an intermediary between the nonvolatile storage device 210 and entities (such as applications, other computing devices, etc) that need data units stored on the nonvolatile storage device 210. For example, the client 208 may be a storage manager device in a storage system such as a SAN or a NAS. The client 208 may include more elements or different elements than those shown; for example, a client 208 typically includes a processor to enable its functionality. In certain embodiments, the client 208 may direct computing devices that require data units from the nonvolatile storage device 210 to store and retrieve data units in the nonvolatile storage device 210 using remote direct memory access (RDMA) and/or direct memory access (DMA).

In one embodiment, the deduplication agent 110 sends a hash request 302 to the nonvolatile storage device 210 that implements a hash generation apparatus 230. In the depicted embodiment, the hash generation apparatus 230 is implemented as part of the storage controller 212. The hash generation apparatus 230 may also be implemented elsewhere in the nonvolatile storage device 210; for example, the hash generation apparatus 230 may be fully or partially hardware. The nonvolatile storage device 210 shares information with the client 208 over a second communications connection 350. The second communications connection 350 may be a network, bus, or other connection that allows electronic information to be shared between the client 208 and the nonvolatile storage device 210. The second communications connection 350 is separate from the first communications connection 360 that allows the storage controller 212 to send and retrieve information from the nonvolatile storage 214.

The hash request 302 requests the hash for a data unit stored in the computing device that implements the hash generation apparatus 230; in this case, the nonvolatile storage 214 of the nonvolatile storage device 210. The hash request includes a data unit identifier that identifies the data unit for which the hash is requested. The identifier maybe a name (such as a file name), an address, a range, a logical address, or other way of identifying a data unit in nonvolatile storage 214. The data unit identifier, in certain embodiments, may also be a list or other data structure comprising PBAs or LBAs for the constituent parts of the data unit. The hash request 302 may additionally include a request to read the data unit.

In certain embodiments, the deduplication agent 110 may track which data units it has deduplicated and which data units it has not deduplicated. In such an embodiment, the deduplication agent 110 may send hash requests 302 identifying the data units that have not been deduplicated and requesting hashes of those data units. The deduplication agent 110 may send multiple hash requests 302, or a single hash request 302 that includes multiple data unit identifiers.

In other embodiments, the hash generation apparatus 230 may be responsible for tracking which data units have been deduplicated. In such an embodiment, the hash generation apparatus 230 may include a tracking module 318. The tracking module 318 tracks which data units on the host device, here the nonvolatile storage 214, have been deduplicated. The tracking module 318 may store information identifying which data units require deduplication in the nonvolatile storage 214, or may use other storage to maintain the information. In one embodiment, each data unit includes a metadata flag indicating whether or not the particular data unit has been deduplicated. In such an embodiment, the tracking module 318 may store the deduplication tracking data in volatile memory and recreate the deduplication tracking data using the metadata flags in the event of a power failure or other event causing loss of the tracking data.

Where the deduplication tracking data is managed by the tracking module 318, the deduplication agent 110 may request the hashes of one or more data units that require deduplication as determined by the tracking module 318. For example, the deduplication agent 110 may send an indication that it is ready to receive hashes from the nonvolatile storage device 120. In other embodiments, the hash generation apparatus 230 pushes the hashes to the deduplication agent 110 without the deduplication agent 110 requesting them.

The storage module 310 writes data units received from the client 208 into the nonvolatile storage 214. The storage module 310 also reads data units out of the nonvolatile storage 214 as requested. In certain embodiments, the client 208 is a file server that sends the data units to the storage module 310. The client 208 may be an entity, such as a remote computer, that sends data units to be written to nonvolatile storage 214 using RDMA and/or DMA approaches. Devices or applications that request that data units be written to nonvolatile storage 214 or read from nonvolatile storage 214 are clients 208.

The input module 312 receives hash requests 302 from requesting entities. A requesting entity is a device, application, module, or other entity that requests that the hash module 314 generate a hash for a data unit. The deduplication agent 110 may be a requesting entity. The requesting entity may be another nonvolatile storage device. The requesting entity may be another module, such as the tracking module 318, within the nonvolatile storage device 210. While FIG. 3 shows the hash request 302 originating with the deduplication agent 110 on the client 208, the hash request 302 may also originate within the hash generation apparatus 230.

For example, in certain embodiments, the tracking module 318 may request that data units stored in the nonvolatile storage 214 be deduplicated. The tracking module 318 may send one or more hash requests 302 after a particular period of time has passed since the last deduplication (or since the data unit was last updated), or may send hash requests 302 to the input module 312 once a certain threshold number of data units have not been deduplicated. In such embodiments, and other embodiments where a module internal to the nonvolatile storage device 210 send the hash request 302, the internal module is the requesting entity. Other modules within the storage controller 212 may also be requesting entities; for example, a garbage collection module may trigger a deduplication operation as described below. Thus, the arrow in FIG. 3 showing the hash request 302 coming from an external source is not a limitation on where the requesting entity is located.

The hash request 302 requests a hash of the specified data unit and includes a data unit identifier that identifies the one or more data units for which hashes are requested. In certain embodiments, the hash request 302 is sent from the client 208 along with, or as part of, a request to store the data unit for which the hash is requested on the nonvolatile storage device 210. The hash module 314 generates a hash for the data units identified in the hash request 302. The hash module 314 generates the hashes for the data units using hash functions which are executed against the data units. In certain embodiments, the hash module 314 may use Message Digest Algorithm 5 (MD5), Secure Hash Algorithms (SHA-1, SHA-2), error correcting code, fingerprints, or other algorithm that can be used to generate hashes suitable for identifying data units for which hashes are produced. Other approaches for generating a hash may also be used.

In certain embodiments, the hash module 314 generates the hash for the data unit when the input module 312 receives the hash request 302. The input module 312 may send the hash module 314 an instruction to generate the hash or otherwise invoke the hash generating functionality of the hash module 314. For example, the input module 312 may receive a hash request 302 and instruct the hash module 314 to generate a hash for the identified data unit. The hash module 314 may then generate the hash for the data unit in response.

In other embodiments, the hash module 314 may generate the hash during the write process for the data unit. For example, the storage module 310 may receive a data unit to be written to the nonvolatile storage 214. The storage module 310 may request that the hash module 314 generate a hash for the data unit as part of the write process. The hash module 314 may then generate the hash and store the hash in nonvolatile storage 214 (or volatile memory) and associate the hash with the data unit. In another embodiment, the hash module 314 may be invoked to generate the hash during a read operation on the data unit. The actual generation of the hash may not be synchronous with the read operation. In a nonvolatile storage device 210 such as that described in “Apparatus, System, and Method for Managing Data Using a Data Pipeline”, referenced above, the hash module 314 may be part of the write data pipeline or read data pipeline, or may be invoked as the data unit moves through the write data pipeline or read data pipeline, or garbage collection bypass.

The transmission module 316 sends the hash to a receiving entity in response to the input module 312 receiving the hash request 302. In one embodiment, the receiving entity may be the same as the requesting entity; for example, the deduplication agent 110 may be the requesting entity that sent the hash request 302, and may also be the receiving entity that receives the hash 304 generated in response to the hash request 302. In one embodiment, the receiving entity uses the hash 304 to determine whether or not the particular data unit is a duplicate of a data unit already stored in a storage system.

That the transmission module 316 sends the hash 304 to the receiving entity in response to the input module 312 receiving the hash request 302 does not preclude intermediate actions occurring between receipt of the hash request 302 and transmission of the hash 304. For example, the hash module 314 may generate the hash 304 for the data unit as an intermediate step. Other actions discussed in this application may also be performed as intermediate steps.

In one embodiment, the transmission module 316 makes a determination as to whether or not a hash has been generated for the data unit by the hash module 314 prior to the input module 213 receiving the hash request. For example, the hash 304 may have been created by the hash module 314 when the data unit was being written to the nonvolatile storage 214, which write operation may have occurred prior to the input module 312 receiving the hash request 302. If the hash module 314 has already generated a hash 304 for the data unit, the transmission module 316 retrieves the hash 304 and sends the hash 304 to the receiving entity.

In certain embodiments, the transmission module 316 also verifies whether a pre-generated hash 304 of the data unit is still valid before sending the hash 304 to a receiving entity. For example, the hash 304 may have been generated for the data unit prior to receipt of the hash request 302, but the data unit may have been modified since the hash 304 was created. In this instance, the hash 304 may no longer be valid, in which case the transmission module 316 may instruct the hash module 314 to generate a new hash for the data unit using the current version of the data unit.

In the embodiment shown in FIG. 3, the deduplication agent 110 is the requesting entity. The deduplication agent 110 sends a hash request 302 to the nonvolatile storage device 210. The input module 312 of the storage controller 212 receives the hash request 302, which includes a data unit identifier and requests a hash of the data unit. The hash module 314 may have already generated the hash 304 for the data unit, or may generate the hash 304 in response to the input module 312 receiving the hash request 302. The transmission module 316 sends the hash 304 to a receiving entity; in this case, the receiving entity is the deduplication agent 110, and the hash is sent over a communications connection between the client 208 and the nonvolatile storage device 210.

As a result, in certain embodiments, the traffic on the connection between the client 208 hosting the deduplication agent 110 and the nonvolatile storage device 210 is reduced. Rather than passing the entire data unit to the deduplication agent 110 over the connection, a smaller hash 304 is passed instead. In addition, the strain on the resources of the client 208 (such as RAM 112) is greatly reduced or avoided altogether. In addition, in certain embodiments, the deduplication agent 110 never touches the data; that is, the deduplication agent 110 never has to create a local version of the data unit (for example, by storing the data unit in RAM 112) in order to perform data deduplication. The deduplication agent 110 performs deduplication by communicating messages over a control path.

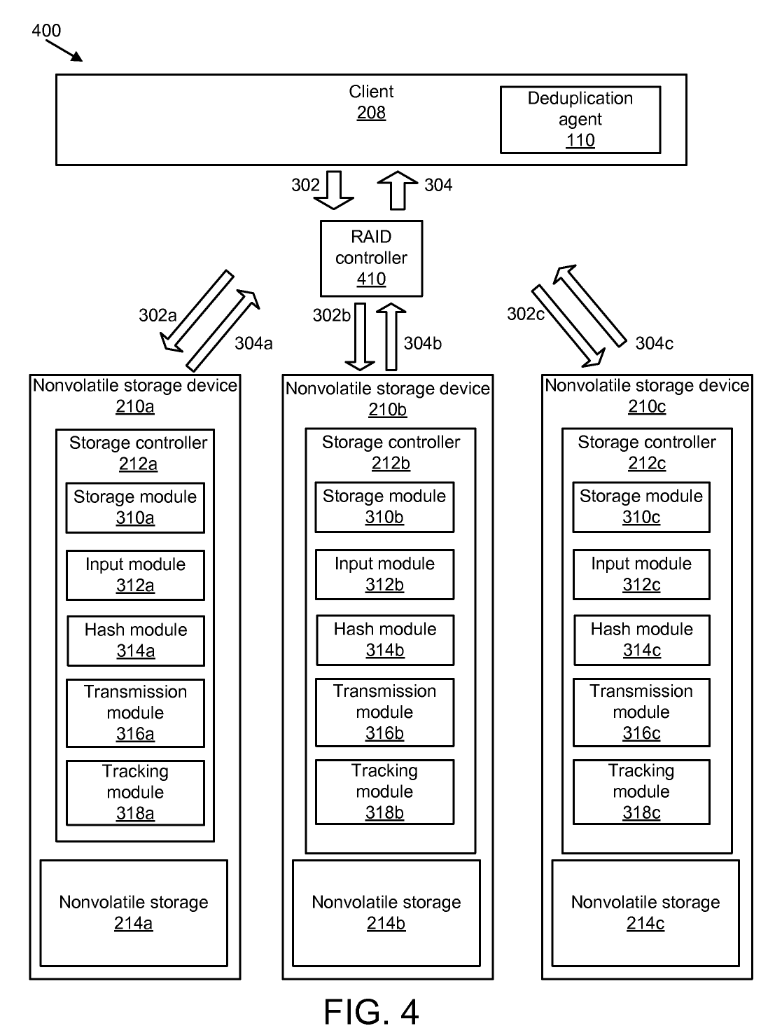

FIG. 4 shows an illustrative example of a system 400 with improved deduplication. The system 400 includes a client 208 (substantially similar to the client 208 described above), a RAID controller 410, and nonvolatile storage device 210a-c. In the system 400, the nonvolatile storage device 210a-c are arranged as a redundant array of independent drives, or RAID (also commonly referred to as a redundant array of inexpensive disks or by other variations on the acronym).

The RAID controller 410 implements a RAID storage scheme on an array of nonvolatile storage devices 210a-c. The RAID controller 410 may be a software RAID controller or a hardware RAID controller. Typically, the client 208 or other attached computing device will only see RAID virtual disks; that is, the nonvolatile storage devices 210a-c are transparent to the client 208. The RAID controller 410 may organize the nonvolatile storage devices 210a-c into a RAID 0, RAID 1, RAID 5, RAID 10, RAID 50, or other RAID configuration. In one embodiment, the RAID controller 410 receives the hash requests 302 and makes assignments and determinations necessary to return the hash. In other embodiments, this functionality is distributed across various devices such as the nonvolatile storage devices 210a-c.

In many embodiments, the RAID controller 410 receives RAID data blocks from the client 208 (such as a file), divides the RAID data block into data segments, and stripes the data segments across the nonvolatile storage devices 210a-c as a RAID data stripe. The RAID controller 410 may also generate parity segments and store them across the nonvolatile storage devices 210a-c. In such embodiments, the data units stored in the individual nonvolatile storage device 210a-c may be segments of the RAID data stripe (such as data segments or parity segments) generated for the RAID data block.

As described above, the client 208 may include a deduplication agent 110. The deduplication agent 110 may send a hash request 302 identifying a particular RAID data block for deduplication and requesting a hash for the data block. In one embodiment, the RAID controller 410 receives the hash request 302 and determines where the data segments for the RAID data block to be deduplicated are located. The RAID controller 410 may then transform the hash request 302 into multiple hash requests 302a-c that identify the relevant data segments on each of the nonvolatile storage device 210a-c and that request hashes for those data segments from each relevant nonvolatile storage device 210a-c.

In certain embodiments, the RAID controller 410 may pass the hash request 302 to the nonvolatile storage devices 210a-c. In such an embodiment, the input modules 312a-c of the respective nonvolatile storage devices 210a-c may have access to information about the relationship between the identifier for the data unit given to the nonvolatile storage devices 210a-c and the actual storage of the data unit to determine which data segments stored by the nonvolatile storage devices 210a-c are relevant to the hash request 302. For example, the nonvolatile storage devices 210a-c may be able to map a file name to particular LBAs. Having received the hash request 302, the nonvolatile storage devices 210a-c may then respectively generate the appropriate hashes for the data segments that each nonvolatile storage device 210a-c stores. For example, a hash request 302 requesting a hash for a RAID data block A may be forwarded to the nonvolatile storage device 210a. The nonvolatile storage device 210a may receive the hash request 302, determine that it stores data segment A₁ of the RAID data block A, generate the hash for the data segment A₁, and send the hash to the appropriate receiving entity. Similarly, the nonvolatile storage device 210b may receive the same hash request 302 and determine that it stores data segment A₂ of the RAID data block A, generate the hash for the data segment A₂, and send the hash to the appropriate receiving entity.

Approaches to transmitting the hash request 302 to the nonvolatile storage device 210a-c may also vary based on the RAID configuration. For example, in a RAID 1 mirror, the RAID controller 410 may simply pass the hash request 302 to one of the nonvolatile storage device 210a-c since each nonvolatile storage device 210a-c would return the same hash.

In one embodiment, the RAID controller 410 receives the hashes 304a-c from the nonvolatile storage devices 210a-c, representing partial results of the hash 304 generated for the data segments within each of the respective nonvolatile storage devices 210a-c, and creates a hash 304 for the entire data block using the partial hashes 304a-c. In other embodiments, the hashes 304a-c may go to the client 208 and are there assembled into the hash 304 using the partial results 304a-c. In certain embodiments, such as that depicted in FIG. 4, each nonvolatile storage device 210a-c sends the hash 304a-c generated for the relevant data unit to the RAID controller 410 over a communications connection.

In certain embodiments, each nonvolatile storage device 210a-c can generate a hash 304a-c for the data unit stored in the particular nonvolatile storage device 210a-c without the hash generated by another nonvolatile storage device 210a-c. For example, nonvolatile storage device 210a may store a first data segment A₁, and the nonvolatile storage device 210b may store a second data segment A₂ for the data block A that is to be deduplicated as directed by the hash request 302. Certain hash algorithms may allow the nonvolatile storage device 210b to calculate a hash for the second data segment A₂ without knowing the hash of the first data segment A₁ stored on nonvolatile storage device 210a. In such embodiments, the nonvolatile storage device 210a and nonvolatile storage device 210b may generate the hashes 304a and 304b in parallel operations and send the hashes 304a and 304b to the RAID controller 410, which may construct the complete hash 304 from the partial results provided by the nonvolatile storage device 210a and 210b.

Such hashing algorithms may be generally referred to as independent hashing algorithms; that is, hashes may be generated for each data segment independently, and the hashes, representing partial results, may be combined to form the hash for the RAID data block as a whole. For example, a RAID data block A may be divided into two pieces, A₁ and A₂. Executing the hash algorithm on A gives the same result as executing the hash algorithm on A₁ and A₂ and then combining the partial results.

In other embodiments, as mentioned above, the hash request 302 is broadcast to the nonvolatile storage device 210a-c, and the nonvolatile storage device 210a-c determines which data units are affected by the hash request 302, generate the hashes 304a-c on the affected data units, and returns the hashes 304a-c to the requesting entity such as the RAID controller 410. In other embodiments, the nonvolatile storage device 210a-c may pass the hash 304a-c to the client 208 instead of the RAID controller 410. In such an embodiment, the input module 312a-c may determine that the nonvolatile storage 214a-c contains a data unit that is part of the hash request 302 and direct the hash module 314a-c to generate the hash for the data unit. The transmission module 316a-c then sends the hash to a receiving entity, such as the RAID controller 410, the client 208, or one of the other nonvolatile storage devices 210a-c.

For example, the RAID controller 410 may broadcast the hash request 302 identifying data block A as the data block to be deduplicated. Input module 312a receives the hash request 302 and determines that the nonvolatile storage 214a contains data segment A₁, which is a segment of RAID data block A. The transmission module 316a sends the hash of data stripe A₁ to a receiving entity, which may, in certain embodiments, be the RAID controller 410, the client 208, or the nonvolatile storage device 210b that contains data segment A₂. Nonvolatile storage device 210b may undergo a similar process for data stripe A₂. The input module 312c may determine that it holds a parity stripe for data block A and determine that it does not need to return a hash on the parity stripe. In certain embodiments, the hash module 314c does not generate a hash on data units that are parity segments. In other embodiments, the nonvolatile storage device 210c may generate a hash for a parity segment.

In one embodiment, the hash generation process proceeds sequentially, with the various hashes produced in a specified order, using previous results, to generate the hash of the RAID data block. For example, the RAID controller 410 may send a hash request 302a to the nonvolatile storage device 210a with data segment A₁. The RAID controller 410 may wait to send a hash request 302b to the second nonvolatile storage device 210b until the nonvolatile storage device 210a sends the hash of the data segment A₁ to the RAID controller 410. In certain embodiments, the RAID controller 410 then sends the hash of the data segment A₁ to the nonvolatile storage device 210b, which uses the hash of the data segment A₁ as a seed in generating the hash of the data segment A₂.

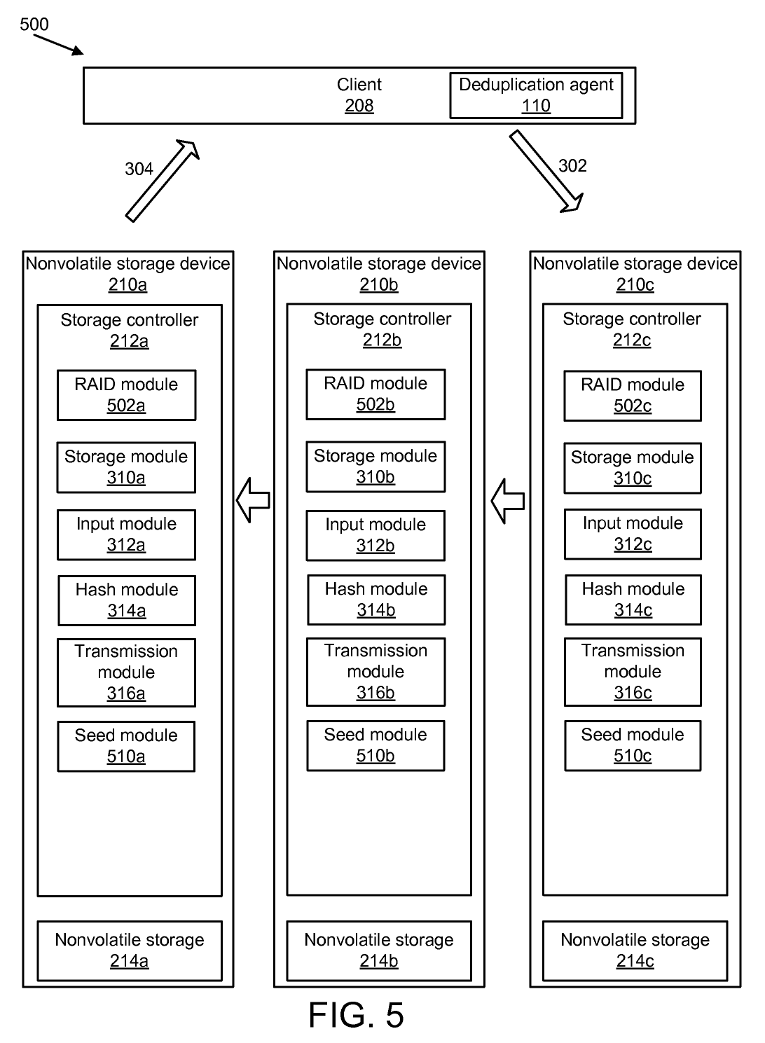

FIG. 5 shows a second embodiment of a system 500 for improved deduplication in a RAID environment. The system includes a client 208, which may be substantially similar to that described above, and nonvolatile storage devices 210a-c configured as storage in a RAID system. As noted above, the system 500 may be configured as a RAID 0, RAID 5, or other RAID configuration. The system 500 and description is given as an example, and not by way of limitation of the invention.

In one embodiment the RAID controller functionality is located on one or more of the nonvolatile storage devices 210a-c. The RAID controller may be distributed between the nonvolatile storage device 210a-c. In the depicted embodiment, the storage controllers 212a-c each include a RAID module 502a-c. patent application Ser. No. 11/952,116, filed Dec. 6, 2007 for David Flynn, John Strasser, Jonathan Thatcher, and Michael Zappe entitled “Apparatus, System, and Method for a Front-end, Distributed RAID”, which is hereby incorporated by reference in its entirety, teaches one approach to distributed RAID. In one embodiment, the RAID modules 502a-c are front-end distributed RAID apparatus as taught in the aforementioned application at paragraph 268 through 345. The RAID modules 502a-c may be software RAID or hardware RAID modules.

In one embodiment, the client 208 sends a hash request 302 to the nonvolatile storage device 210c. In one embodiment, the client 208 may be aware of a master RAID module 502 and send the hash request 302 to the master RAID module 502. In the depicted embodiment, the RAID module 502c may be the master RAID module and receive the hash request from the client 208. In other embodiments, the client 208 may broadcast the hash request 302 to all nonvolatile storage device 210a-c, and the RAID modules 502a-c make an appropriate determination as to what to do with the hash request 302. For example, in one embodiment, the RAID modules 502a-c may ignore hash requests 302 if they determine that the nonvolatile storage device 210a-c associated with the RAID module 502a-c does not have the first data segment for the RAID data block to be deduplicated.

In certain embodiments, the hash 304 cannot be generated for a RAID data block by independently generating sub-hashes on the data stripes and combining the sub-hashes; that is, the hash of data stripe A₁ may be necessary to generate the hash of the data stripe A₂, and so forth. Thus, the partial hashes must be generated sequentially in order to construct the hash for the entire data block.

In one embodiment, the RAID module 502c determines that the nonvolatile storage device 210c has the first data segment for the particular data block to be deduplicated. The RAID module 502c may then act as a requesting entity and send a hash request 302 to the input module 312c. In one embodiment, the requesting entity (in this case, the RAID module 502c) may also send a seed. In such embodiments, a seed module (such as seed modules 510a-c) receives the seed and provides the seed to the hash module 314a-c. The hash module 413a-c uses the seed to generate the hash for the data segment.

In certain embodiments, the seed may be sent as part of the hash request 302. In other embodiments, the seed may be sent separately from the hash request 302. In one embodiment, the nonvolatile storage device 210c that holds the first data segment for the RAID data block does not receive a seed. In other embodiments, the seed for the nonvolatile storage device 210c holding the first data segment may be a set of bits all set to 0.

The hash module 314c generates a hash for the first data segment and the transmission module 316c sends the hash for the data segment to a receiving entity. In one embodiment, such as that shown in FIG. 5, another nonvolatile storage device 210b is the receiving entity. In one embodiment, the transmission module 316c transmits the hash of the data segment as part of the hash request 302, which the transmission module 316c sends to the nonvolatile storage device 210b. The RAID module 502c, in one embodiment, is aware of where the second data segment is located and instructs the transmission module 316c to send the hash of the first data segment as part of a hash request to the entity (in this case nonvolatile storage device 210b) that has the second data segment. The RAID module 502c may also have the hash of the first data segment pushed to it by the entity that has the second data segment. In one embodiment, the transmission module 510c also indicates that the hash of the first data segment is a seed to be used in generating the hash of the second segment.

The input module 312b receives the hash request 302 from the nonvolatile storage device 210c, which nonvolatile storage device 210c is the requesting entity from the perspective of the input module 312b. The seed module 510c receives the seed, which in this instance is the hash generated on the first data segment by the hash module 314c. The hash module 314b uses the hash of the first data segment as a seed to generate the hash of the second data stripe stored in nonvolatile storage 214b.

In one embodiment, the process of generating a hash and sending the hash to the next nonvolatile storage device 210a-c for use as a seed continues until a complete hash for the data block that is the subject of the hash request 302 is complete. Once the complete hash has been generated, the hash 304 is sent to the appropriate entity. In one embodiment, the appropriate entity is the deduplication agent 110 on the client 208. In other embodiments, the appropriate entity may be one or the nonvolatile storage devices 210c, such as the nonvolatile storage device 210c with the master RAID module 502c.

In certain embodiments, the nonvolatile storage device 210a-c are connected by a communications connection, such as a network or a bus, separate from the communications connection that connects the nonvolatile storage device 210a-c and the client 208. In such an embodiment, the nonvolatile storage devices 210a-c can communicate between themselves without disrupting or adding to traffic on the connection between the nonvolatile storage devices 210a-c and the client 208. As a result, deduplication operations may occur on the nonvolatile storage devices 210a-c with minimal burden on the bus (or other connection) that links the nonvolatile storage devices 210a-c and the client 208. In addition, the client 208 may perform other read and write operations on the nonvolatile storage device 210a-c while the deduplication process is occurring. In certain embodiments, deduplication processes (including hash generation) may be interrupted or paused in order to allow other operations to take precedence. Removing deduplication from the data path thus provides improved availability and improved performance.

In one embodiment, the deduplication agent 110 is situated on one or more of the nonvolatile storage devices 210a-c instead of the client 208. In such an embodiment, traffic on the communications connection connecting the nonvolatile storage devices 210a-c and the client 208 may be further reduced as deduplication operations, and associated requests and data, moves only across the communications connection that interconnects the nonvolatile storage devices 210a-c. The deduplication agent 110 may also be located in other locations in the system 400, including within one of the nonvolatile storage devices 210a-c, the RAID controller 410, distributed across multiple nonvolatile storage devices 210a-c or clients 208, or in other locations.

In certain embodiments, the hash module 314a-c does not generate a hash for a particular data unit stored in nonvolatile storage 214a-c until after the seed module 510a-c receives a seed hash and provides the seed to the hash module 314a-c. In one embodiment, the hash module 314a-c does not receive the seed and generate the hash until the hash request 302 has been sent. Thus, in one embodiment, the flow of the process maybe: a first input module 310c receives a hash request 302 and the first seed module 510c receives the seed; the hash module 314c generates the hash using the seed; the transmission module 316c transmits the hash request and the hash, which is used designated a seed, to a nonvolatile storage device 210b. The process then repeats for the next data segment stored on the nonvolatile storage device 210c.

In other embodiments, the hash module 314a-c and the seed modules 510a-c may generate and store a hash for a data block before a hash request 302 for that data block is received. For example, a RAID module 502c may receive a data block A to be stored and direct the storage of data segments A₁, A₂, and parity segment A₃ within the nonvolatile storage devices 210a-c. In one embodiment, the RAID module 502c instructs the hash module 314c to generate a hash on the data block A and to store the hash in volatile or nonvolatile storage 214c prior to striping the data block A across the nonvolatile storage devices 210a-c.

In another embodiment, the RAID module 502c may instruct the hash module 314c to generate a hash for the data block A prior to receiving a hash request 302 and after the data block is striped across the nonvolatile storage devices 210a-c. In one embodiment, the RAID module 502c instructs the hash module 314c to generate a hash for the data segment A₁ and directs the transmission module 316c to send the hash, for use as a seed, to the nonvolatile storage device 210b which stores the data segment A₂. In this manner, the RAID module 502c may coordinate creation of the hash for the data block A using the partial hashes of the data segments stored in the nonvolatile storage devices 210a-c. The RAID module 502c may store the hash in nonvolatile storage 214c for retrieval when a requesting entity requests a hash for the data block A.

In another embodiment, the RAID module 502c may request that the nonvolatile storage devices 210a-b send the data segments to the RAID module 502c. The RAID module 502c may also request that the nonvolatile storage devices 210a-b send the data segments to the client 208 as part of, or in conjunction with, a write operation. The RAID module 502c may then assemble the data block A, instruct the hash module 314c to generate a hash on the data block A, and store the hash in nonvolatile storage 214a-c. The hash for the data block A may then be retrieved when a requesting entity requests a hash for the data block A. The RAID module 502c may wait to trigger generation of hashes at an opportune time; for example, the RAID module 502c may wait until there are spare cycles and low traffic on the communications connection between the nonvolatile storage devices 210a-c before initiating generation of the hash. In other embodiments, the RAID module 502c may initiate hash generation on a set schedule defined by a systems administrator. In other embodiments, the RAID module 502c identifies hash generation processes as low priority processes that are executed only after high priority processes (such as, for example, reads and writes of data units) have executed.

In other embodiments, triggering generation of the hash at an opportune time involves generating the hash in conjunction with other operations. For example, hash generation may be triggered in conjunction with a rebuild operation for the data unit, a progressive RAID operation, a garbage collection operation, a backup operation, a cache load operation, a cache flush operation, a data scrubbing operation, a defragmentation operation, or other operation affecting all or part of a particular data unit.

Thus, in various exemplary embodiments, the RAID module 502c may coordinate generation of the hash for a RAID data block striped across nonvolatile storage devices 210a-c by passing a hash for a locally stored data segment along with control to a different nonvolatile storage device 210b that locally stores another data segment of the data stripe. The RAID module 502c may also coordinate generation of the hash for a RAID data block by requesting that the nonvolatile storage devices 210a-b send the relevant data segments necessary to reconstruct the RAID data block, at which time the hash module 314c generates the hash for the data block.

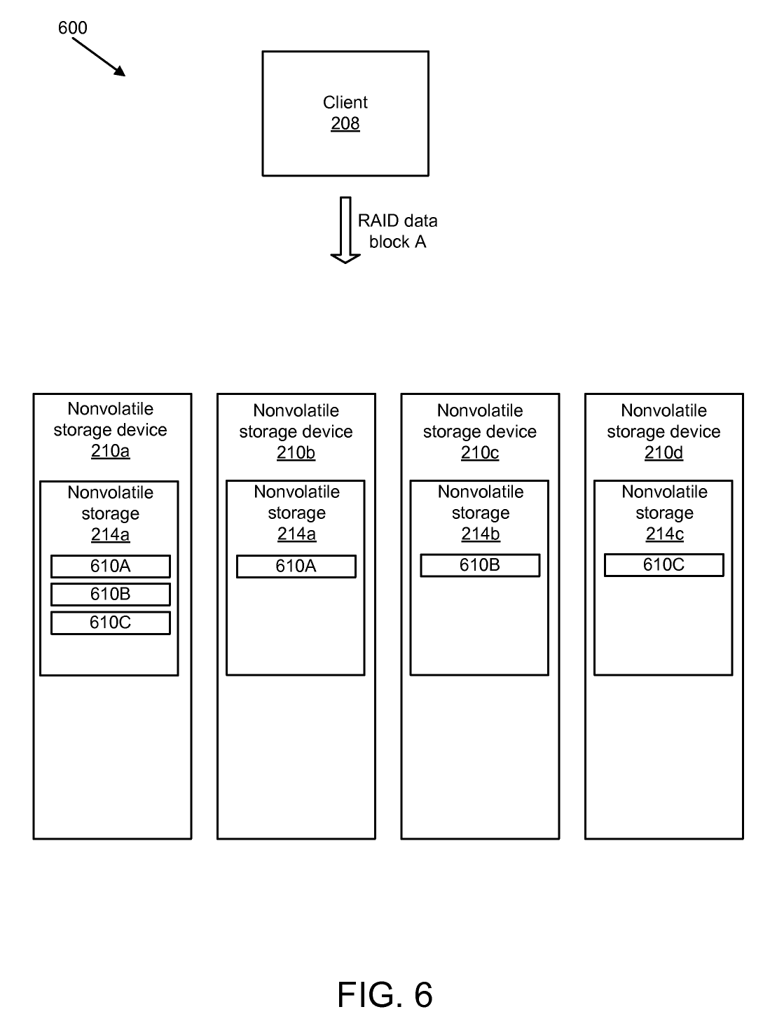

FIG. 6 shows an additional embodiment of a RAIDed system 600 where the nonvolatile storage devices 210a-d are configured as a RAID. In one embodiment, the system 600 includes a RAID controller 410 as shown in FIG. 4; in other embodiments, the RAID controller is distributed across the nonvolatile storage devices 210a-d as RAID modules 502, as shown in FIG. 5. In the depicted embodiment, the client 208 sends a RAID data block A to be stored in the nonvolatile storage devices 210a-d. The RAID data block A may be a file, an object, or other set of data that a client 208 may store in a RAIDed system. In certain embodiments, the RAID controller 410 for the system 600 generates data segments 610A-C for the RAID data block A. In addition, the RAID controller 410 may generate a parity segment for the data block A.

In one embodiment, as described in “Apparatus, System, and Method for a Front-end, Distributed RAID”, one or more of the nonvolatile storage devices 210a-d are configured as parity-mirror storage devices. In other embodiments, the parity-mirror assignment may rotate among the nonvolatile storage devices 210a-d in a manner similar to the rotation of the parity assignment in certain RAID configurations, such as RAID 5. In such embodiments, the RAID controller 410 may write the data segments 610A-C to the parity-mirror storage devices (which is nonvolatile storage device 210a in FIG. 6) in addition to striping the data segments 610A-B across the nonvolatile storage device 210b-d. The parity data for the RAID data block A may then be calculated from the data segments 610A-C stored on nonvolatile storage device 210a at a later time. In such embodiments, the nonvolatile storage devices 210a-d may include parity progression modules that generate parity data to replace the data segments 610A-C on the parity-mirror storage device (nonvolatile storage device 210a in the example shown in FIG. 6) during a storage consolidation operation.

In one embodiment, the nonvolatile storage device 210a includes the modules discussed previously such that the nonvolatile storage device 210a can generate the hash in conjunction with the parity generation process. In one embodiment, the hash module generates the hash using the data segments 610A-C on the mirror-parity storage device during the storage consolidation operation that generates the parity segment from the data segments 610A-C. In one implementation, the parity progression module is the requesting entity that sends the hash request triggering the generation of the hash on the data segments 610A-C. In another implementation, the entity performing the storage consolidation operation and triggering the parity progression module is configured to similarly trigger generation of the hash.

In one embodiment, the hash is generated on the parity data generated for the data block A. Thus, the parity progression module may generate the parity for the data segments 610A-C, and the hash module generates the hash using the parity for the data segments 610A-C instead of the data segments 610A-C themselves.

In certain embodiments, the hash of the data segments 610A-C stored on the parity-mirror device is stored on the parity-mirror device. In other embodiments, the hash of the data stripes 610A-C is stored on a different nonvolatile storage device 210a-c. In certain embodiments, one of the nonvolatile storage devices 210a-d may be selected to store the hashes for data stored on the system 600. In other embodiments, the hashes are distributed across nonvolatile storage devices 210a-d in the system 600.

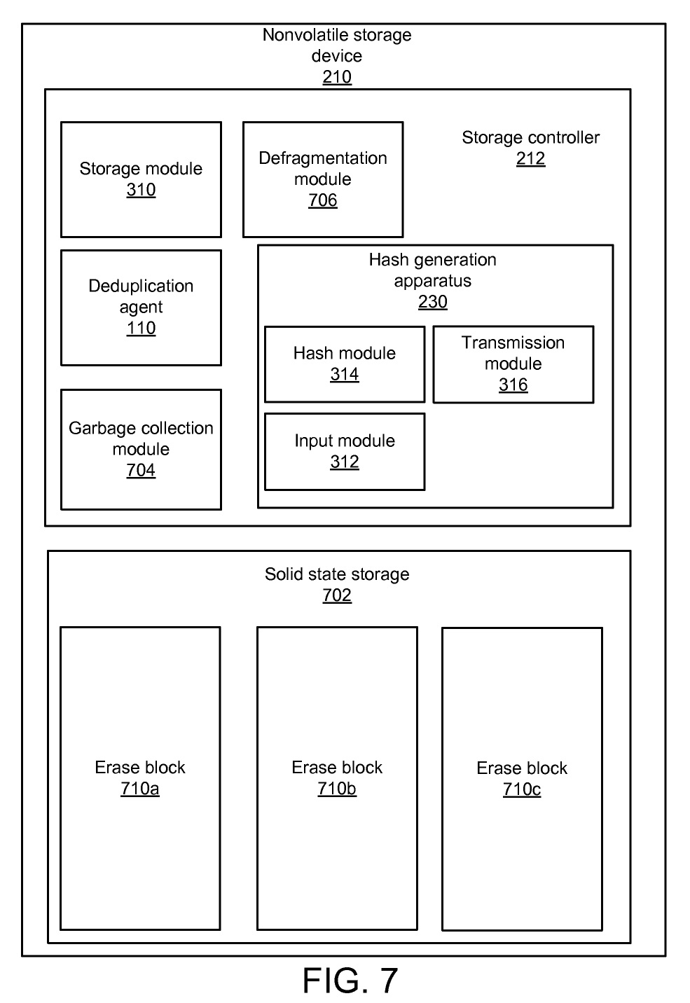

FIG. 7 shows one embodiment of a nonvolatile storage device 210 in which the nonvolatile storage is solid state storage 702. The solid state storage 702 may be NAND flash, PRAM, SRAM, or other nonvolatile solid state storage technology. In the depicted embodiment, the solid state storage 702 includes erase blocks 710a-c. In addition, the storage controller 212 is depicted as including a storage module 310, a garbage collection module 704, a defragmentation module 706, and a hash generation apparatus 230. In certain embodiments, the hash generation apparatus 230 may share all of, or parts of, the logic used to generate parity data, DIF, CRC, checksum, or other data protections. In other embodiments, the hash generation apparatus 230 may be implemented independently.

In many storage devices, such as nonvolatile storage devices 210 with solid state storage 702, the memory may benefit from data grooming. Data grooming refers to management operations that involve relocating data within a memory (such as solid state storage 702) for data integrity, preservation, and device management, independent of a client that is writing or reading data units from a nonvolatile storage device 210. Examples of data grooming operations include garbage collection and logical or physical defragmentation. Data refresh operations, where data is moved after a certain number of read disturbs, are also data grooming operations. Other data grooming operations may also be provided by a nonvolatile storage device 210.

Many solid state memory technologies allow data to be written and read out of pages, or sectors, which are sub-divisions of erase blocks 710a-c. Erase operations, however, occur at the erase block 710a-c level; that is, all pages in an erase block 710a-c are erased together. Solid state memories 702 do not generally support overwrite operations; that is, when data in a page needs to be updated, all of the contents of the erase block 710a-c must be read into a buffer, the entire erase block 710a-c erased, and then the contents of the entire erase block 710a-c must be written back along with the updated data for the particular page. This causes unnecessary delays on the solid state storage 702 and unnecessarily wears the solid state storage 702 as well.

To avoid unnecessary reads, erasures, and writes, the storage controller 212 of solid state storage 702 may include a garbage collection module 704. Broadly speaking, when data on a page is updated, rather than store the updated data in the same page according to the approach outlined above, the updated data is stored in a different page and the data originally stored is marked as invalid. Once a sufficient quantity of data within a block is marked as invalid, the garbage collection module 704 moves the remaining valid data out of the erase block and performs an erase operation on the erase block, thus reclaiming the erase block 710a-c as available for storage.

The garbage collection module 704 recovers erase blocks 710a-c for storage. Patent application Ser. No. 11/952,101 for David Flynn, Bert Lagerstedt, John Strasser, Jonathan Thatcher, John Walker, and Michael Zappe, entitled “Apparatus, System, and Method for Storage Space Recovery in Solid-state Storage” and incorporated herein by reference, describes approaches to garbage collection in solid state storage 702. In particular, paragraphs 200 through 219 discuss garbage collection. In one embodiment, the garbage collection module 704 is implemented in accordance with the aforementioned application. The garbage collection module 704 may also implement a variety of garbage collection techniques known to be effective in recovering space in solid state storage 702.

In the depicted embodiment, the storage controller 212 also includes a deduplication agent 110. The deduplication agent 110 may determine whether or not a particular data unit is a duplicate of a data unit already stored in solid state storage 702. In one embodiment, the deduplication agent 110 makes the determination according to the methods described above. The deduplication agent 110 may also use a variety of approaches known to be effective for determining whether or not a data unit is a duplicate of another data unit stored in a storage system using hashes of the data units.

In one embodiment, the deduplication agent 110 only determines whether a particular data unit stored in solid state storage 702 is a duplicate of another data unit stored in solid state storage 702. In other embodiments, where there are multiple nonvolatile storage devices 210, the deduplication agent 110 also determines whether a particular data unit is a duplicate of a data unit stored in another nonvolatile storage device. In other embodiments, the deduplication agent 110 may be located externally to the nonvolatile storage device 210, as shown, for example, in FIG. 3.

In one embodiment, the garbage collection module 704 triggers a hash request during the garbage collection process for an erase block 710a-c. The erase blocks 710a-c may be physical erase blocks or logical erase blocks. In one embodiment, the garbage collection module 704 is the requesting entity that sends the hash request. In other embodiments, the garbage collection module 704 requests, via control messages, that the deduplication agent 110 send the hash request, in which instance the deduplication agent 110 is the requesting entity.

In one embodiment, the garbage collection module 714 identifies all valid data units in the erase block 610a-c being recovered. The garbage collection module 714 determines which valid data units have already been the subjects of a deduplication operation. In certain embodiments, the garbage collection module 714 places those valid data units that have not been deduplicated into a buffer, requests that the deduplication agent 110 perform a deduplication operation (which determines whether or not the data units are duplicates) on those data units, and awaits the results. Once the deduplication operation is complete, the deduplication agent 110 identifies which data units in the buffer are duplicates, and which are not. The garbage collection module 704 may then store the valid data units which are not duplicates, and flush the buffer without saving the duplicate data units.

In one embodiment, the nonvolatile storage device 210 maintains more than one append point in the solid state storage 702. In one embodiment, the storage module 310 stores all incoming data units that have not been subject to a deduplication operation at one append point, and all incoming data units that have been subject to a deduplication operation at another append point. A particular erase block 710a-c may contain a mix of data that has and has not been deduplicated. The garbage collection module 704 may be configured, during the garbage collection process, to move the data units that have been subject to a deduplication operation to one append point, and the data units that have not been deduplicated to another append point. Since data units that have not been deduplicated are more likely to be invalid than equivalent data units that have been deduplicated, storing like data units together can aid in improving wear on the solid state storage 702. In such an embodiment, the garbage collection module 704 may, but need not, trigger deduplication as a precursor to, or as part of, a garbage collection operation.

In one embodiment, the garbage collection module 714 requests that the deduplication operation be performed prior to initiating the garbage collection process. For example, garbage collection may be initiated once a certain amount of data within a virtual data block is invalid. The garbage collection module 704 may initiate a deduplication operation for data units within a particular virtual erase block once a certain number of the data units are marked invalid. The threshold for triggering deduplication may be set higher or lower than the threshold for garbage collection.

In one embodiment, the garbage collection module 704 identifies data units within the erase block 710a-c being garbage collected that have not been deduplicated, and triggers the deduplication operation on those data units. The garbage collection module 704 may write the data units to a new erase block 710a-c without awaiting the result of the deduplication operation. The garbage collection module 704 may further flag each data unit within the erase block 710a-c as having been deduplicated. In such an embodiment, those data units that the deduplication agent 110 determines are duplicates are marked as invalid in the new erase block 710a-c to which the data units were moved during garbage collection. In one embodiment, the data units that have not been deduplicated are stored at an append point with new data units being written to the solid state storage 702.

In one embodiment, the nonvolatile storage device 210 includes a defragmentation module 706. The defragmentation module 706 detects data units that are highly fragmented and consolidates those data units. For example, a particular data unit, such as a file, may be spread across multiple separate erase blocks 710a-c. In one embodiment, the defragmentation module 706 reads the data unit and consolidates the data unit by storing it more compactly. In certain embodiments, the defragmentation module 706 may trigger a deduplication operation in conjunction with defragmenting the data unit. The defragmentation module 706 may be invoked as part of the deduplication process for highly fragmented data units. For example, the input module 312, having received a hash request, may determine that the data unit for which the hash is requested is highly fragmented, and command the defragmentation module 706 to perform a defragmentation operation in conjunction with the hash module 314 generating the hash for the data unit.

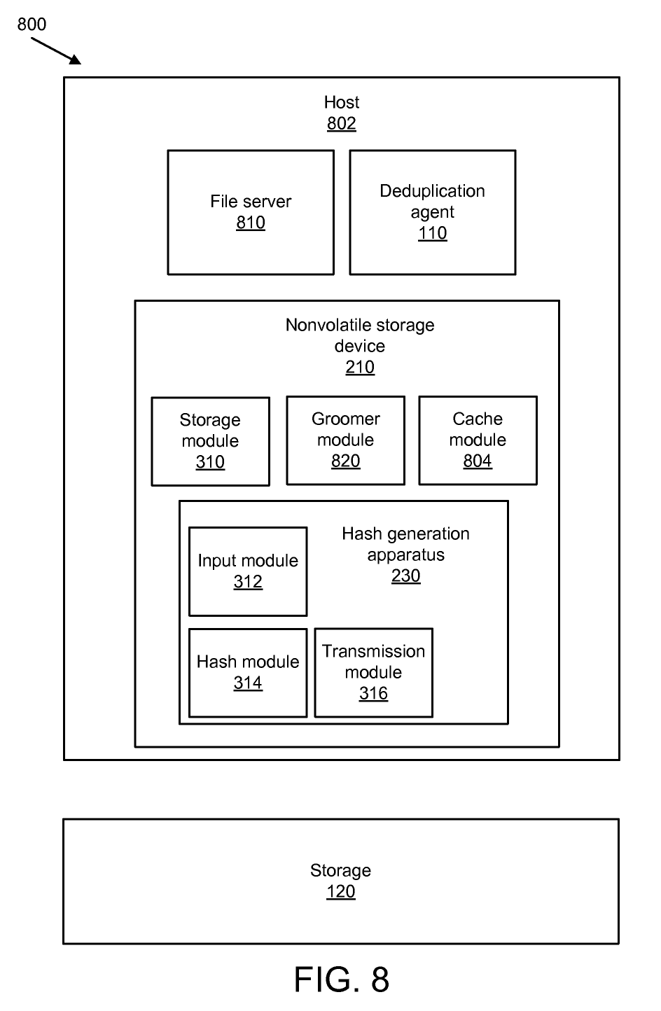

FIG. 8 shows an additional implementation of a system 800 including a host 802 and storage 120. In the embodiment shown in FIG. 8, the nonvolatile storage device 210 is connected to a host 802 and includes a cache module 804. The host 802 may be a server, a personal computer, or other computing device. In the depicted embodiment, the host 802 includes a file server 810 and a deduplication agent 110.

The host 802 is connected to storage 120 such that the host 802 can write and read data from the storage 120. Storage 120 may be tape, hard disk, solid state storage, or other computer readable storage medium. The host 802 may be connected to the storage 120 by a bus, a network, or other mechanism allowing the transfer of data between the host 802 and storage 120. The storage 120 may be internal to the host 802, or external to the host 802.

In one embodiment, the nonvolatile storage device 210 may include a groomer module 820. The groomer module 820 executes various data grooming operations on the data stored in the nonvolatile storage device 210. In certain embodiments, the groomer module 820 includes the garbage collection module 704 and the defragmentation module 706 described in connection with FIG. 7. The groomer module 820 may coordinate with the hash generation apparatus 230 to execute hash generation operations in conjunction with data grooming operations such that the hash is generated at opportune times.

In certain embodiments the nonvolatile storage device 210 acts as a cache for a plurality of client devices. For example, in one embodiment, the host 802 is connected to a plurality of clients and coordinates storage of data sent by the clients, and requested by the clients, on the storage 120. In such an embodiment, the host 802 may use the nonvolatile storage device 210 as a cache for the entire system of clients 800. The nonvolatile storage device 210 may be part of a system memory, and the host 802 may include multiple nonvolatile storage devices 210. The nonvolatile storage devices 210 may be configured to appear as a single, logical storage entity to the host 802.

In one embodiment, the nonvolatile storage device 210 is solid state storage with access parameters that are faster than those associated with the storage 120. Where the storage 120 is a SAN or a NAS, the nonvolatile storage device 210 may act as a cache for the SAN or the NAS. The cache module 804 implements cache algorithms that determine when data is retrieved from storage 120 and moved onto the nonvolatile storage device 210, and when data is moved from the nonvolatile storage device 210 and onto the storage 120. In one embodiment, data units that are regularly accessed are kept in the nonvolatile storage device 210 while data units that have grown cold are moved onto storage 120.

In the depicted embodiment, the nonvolatile storage device 210 includes a hash generation apparatus 230. The hash generation apparatus 230 may perform the hash generation functions described above. In other embodiments, the hash generation apparatus 230 is located in the storage 120. In other embodiments, the hash generation apparatus 230 is distributed across multiple devices.

In the depicted embodiment, the nonvolatile storage device 210 includes a cache module 804. The cache module 804 implements the caching algorithms for the nonvolatile storage device 210 and determines when a particular data unit should be moved out of the nonvolatile storage device 210 and onto the storage 120. In one embodiment, the cache module 804 also participates in managing deduplication processing by the deduplication agent 110.

In one embodiment, the cache module 804 initiates a deduplication process for a data unit when that data unit is about to be moved out of the nonvolatile storage device 210 and onto the storage 120. In certain embodiments, the cache module 804 requests that the deduplication agent 110 determine whether or not the data unit is a duplicate before the data unit is moved onto the storage 120. The cache module 804 may request that the deduplication agent 110 manage the process and simply acknowledge when the deduplication process is complete. In other embodiments, the cache module 804 acts as the requesting entity and generates a hash request which is sent to the input module 312.

In one embodiment, the cache module 804 provides the deduplication agent 110 with information on data units that are being regularly accessed in the nonvolatile storage device 210. A data unit may be accessed, for example, by a read request, a write request, or a modify request. The cache module 804 may identify certain data units as hot data units that are being regularly updated, and those data units that are not being frequently updated as cool data units. In certain embodiments, the cache module 804 may have a predefined access number (for example, accesses per hour) and all data units that have a calculated access number above the predefined access number are designated as hot data units.

The deduplication agent 110 may be configured to delay any deduplication operations on any data units identified by the cache module 804 as non-ideal candidates for data deduplication. In one embodiment, the cache module 804 identifies hot data units as non-ideal candidates for data deduplication. In certain embodiments, the deduplication agent 110 may delay or deny any deduplication operations on a data unit if it is a non-ideal candidate for deduplication. In one embodiment, the cache module 804 instructs the deduplication agent 110 to add and/or remove certain data units from the list of non-ideal candidates. In another embodiment, the cache module 804 sends an updated list of non-ideal candidates at regular intervals, and the updated list replaces the old list.

In one embodiment, the deduplication agent 110, along with the other modules discussed above, do not perform deduplication operations on those data units which are identified by the cache module 804 as non-ideal candidates. For example, the cache module 804 may prevent hash generation and deduplication of data units that are being frequently updated. Since these data units are likely to change again shortly, performing deduplication on hot data units may be inefficient.

In certain embodiments, the cache module 804 communicates information concerning which data units are non-ideal candidates for deduplication with the groomer module 820. In certain embodiments, the groomer module 820 may not request hash generation for those data units that are identified as non-ideal candidates even when those data units are subject to data grooming operations.

In certain embodiments, the data unit may exist in both the nonvolatile storage device 210 and the storage 120. The data unit may also be pinned in the nonvolatile storage device 210. In such embodiments, the deduplication operation does not necessarily remove data units from the cache such that only one copy of the data unit is stored anywhere in the system; rather, the deduplication operation allows for known duplication of data units that are maintained by the system. Rather, as discussed below, the deduplication operation allows for multiple physical copies of a single logical copy of a data unit. The copy of the data unit in the nonvolatile storage device 210 that is configured as a cache, and the copy of the data unit stored in the storage 120, may be part of the single logical copy of the data unit.

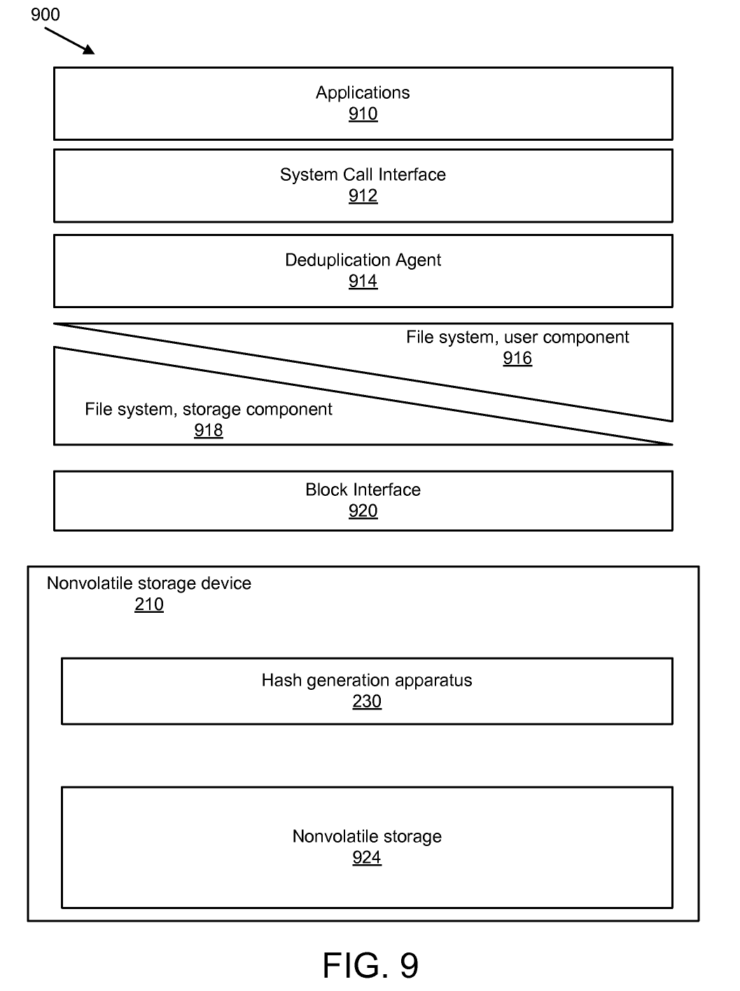

FIG. 9 shows a model of a system 900 for improved deduplication. In one embodiment, the system 900 is a block-based system. Applications 910 read and write data from the nonvolatile storage device 210 using the system call interface 912. The deduplication agent 914 performs data deduplication operations for the system 900. In certain embodiments, the deduplication agent 914 is part of the file system. The file system can be visualized as having two parts: the user component 916 and the storage component 918.

The file system typically provides a one-to-many mapping for data units that are stored in the nonvolatile storage device 210. The file system maps a data unit label (such as a filename, object ID, inode, path, etc) to the multiple locations (such as LBAs or PBAs) where the data unit is stored in the nonvolatile storage device 210. The user component 916 provides an interface for the applications 910 accessing logical data structures and generally receives one of the data unit labels mentioned above. As a result, much of the complexity of storing data units is hidden from those devices and applications above the user component 916 in the stack; for example, an application 910 need only provide a filename and doesn't need to know the details of the LBAs or PBAs for the data unit in the nonvolatile storage device 210.

The storage component 918 maps the data unit label to the multiple locations that identify where the data unit is stored. As noted above, the multiple locations may be logical block addresses (LBAs), physical addresses such as physical block addresses (PBAs), or others. Thus, for example, the user component 916 may receive a filename as the data unit label, and the storage component 918 uses various data structures to map that filename to the LBAs where the data associated with that filename is stored in the nonvolatile storage device 210. The storage component 918 may use data structures such as indexes, mapping tables, and others to perform the association. In this manner, the data unit label may identify the multiple locations where the data unit is stored on the nonvolatile storage device 210.

In certain implementations, the nonvolatile storage device 210 does not have sufficient information to determine the relationship between data unit labels and the LBAs or PBAs where the data is actually stored. For example, in the system 900 shown in FIG. 9, the nonvolatile storage device 210 does not contain information about the storage component 918. Thus, if the nonvolatile storage device 210 receives a data unit label identifier that is simply a filename, object ID, or other data unit label, the nonvolatile storage device 210 has insufficient context information to associate that data unit label with the LBAs and/or PBAs.

In such embodiments, the data unit identifier that identifies the data unit for which the hash is requested, as discussed above, cannot be a data unit label only. In such implementations, the data unit identifier may be a data structure that includes the one or more data unit locations that identify where on the nonvolatile storage device 210 the data unit for which the hash is requested is stored. For example, the data unit identifier may be a linked list of LBAs. The data unit identifier may also be a list of physical addresses that specify where the information is stored on the device, such as cylinder-head-sector (CHS) values, PBA values, or others used in data storage devices.

In one embodiment, the application 910 requests to write a data unit to the nonvolatile storage device 210. The deduplication agent 914 receives the request and generates a write request for the data unit which is sent through the depicted layers to the nonvolatile storage device 210. In one embodiment, the write request generated by the deduplication agent 914 does not include the data unit that is to be written, but does include a hash request for the data unit. The nonvolatile storage device 210 may then receive the data unit from the application 910 by way of, for example, a DMA operation. The nonvolatile storage device 210 writes the data unit to the nonvolatile storage 924 and generates a hash for the data unit. The nonvolatile storage device 210 may then generate an acknowledgement that the data unit was successfully written, which acknowledgement is returned to the deduplication agent 914 along with the hash for the data unit. In certain embodiments, the transmission module discussed above sends the hash as part of the acknowledgement.

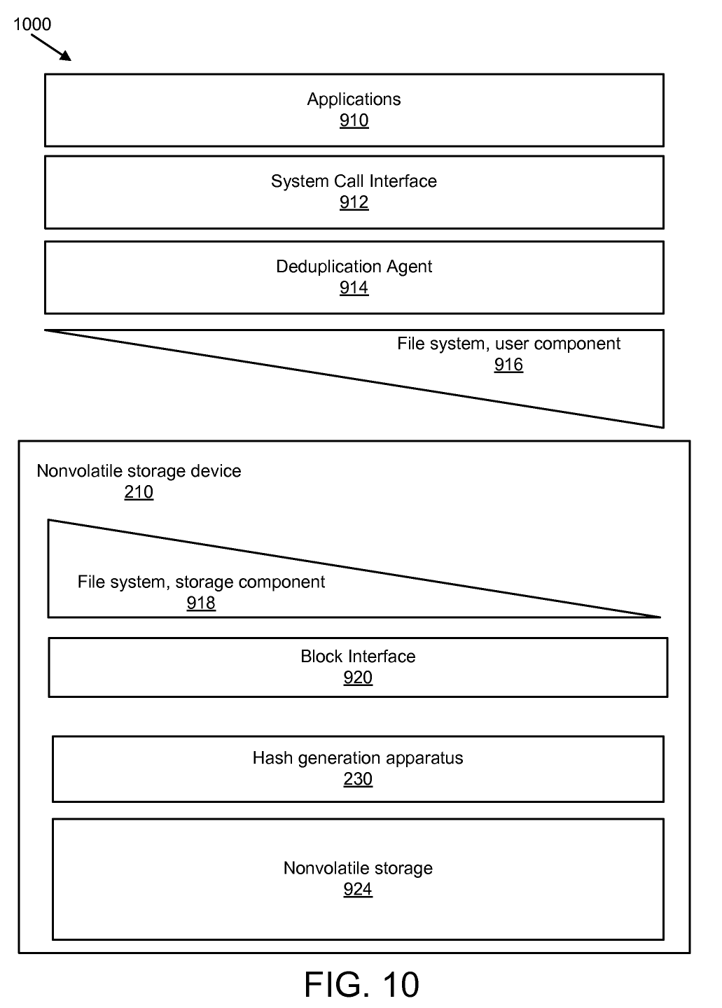

FIG. 10 shows a second embodiment of a model of a system 1000 for improved deduplication. In the depicted embodiment, the storage component 918 of the file system is located on the nonvolatile storage device 210. In one embodiment, the system 1000 is an indirect address storage system. In the embodiment shown, the deduplication agent 914 may use a data unit label as the data unit identifier that is sent to the nonvolatile storage device 210. The nonvolatile storage device 210 may receive the data unit label and make the appropriate associations with data unit locations on the nonvolatile storage 924.

For example, the deduplication agent 914 may request a hash for a file named “fusion.pdf” stored on the nonvolatile storage device 210. The deduplication agent 914 may send the file name “fusion.pdf” as the data unit label, which is received by the nonvolatile storage device 210. In the depicted embodiment, the nonvolatile storage device 210 uses the storage component 918 to determine which LBAs contain the data for the fusion.pdf file. The storage component 918 includes data structures, such as indexes, tables, or others, that associate the filename with data unit locations in nonvolatile storage 924.

In an embodiment such as that shown in FIG. 10, the deduplication agent 914 may provide a data unit label for the data unit and the nonvolatile storage device 210 may make appropriate determinations as to where the data unit is physically stored on the nonvolatile storage 924 using the data unit label. In other embodiments, such as that shown in FIG. 9, the deduplication agent 914 may need to provide a data structure that specifies the data unit locations (such as LBAs and/or PBAs) for the particular data unit for which the hash is requested.

In certain embodiments, the nonvolatile storage device 210 may also receive a data structure that specifies the data unit locations even if the nonvolatile storage device 210 includes information, such as the storage component 918, that would allow the nonvolatile storage device 210 to determine the data unit locations if given the data unit label. In certain embodiments, the storage component 908 may exist both outside the nonvolatile storage device 210 (as shown in FIG. 9) and within the nonvolatile storage device 210 (as shown in FIG. 10).

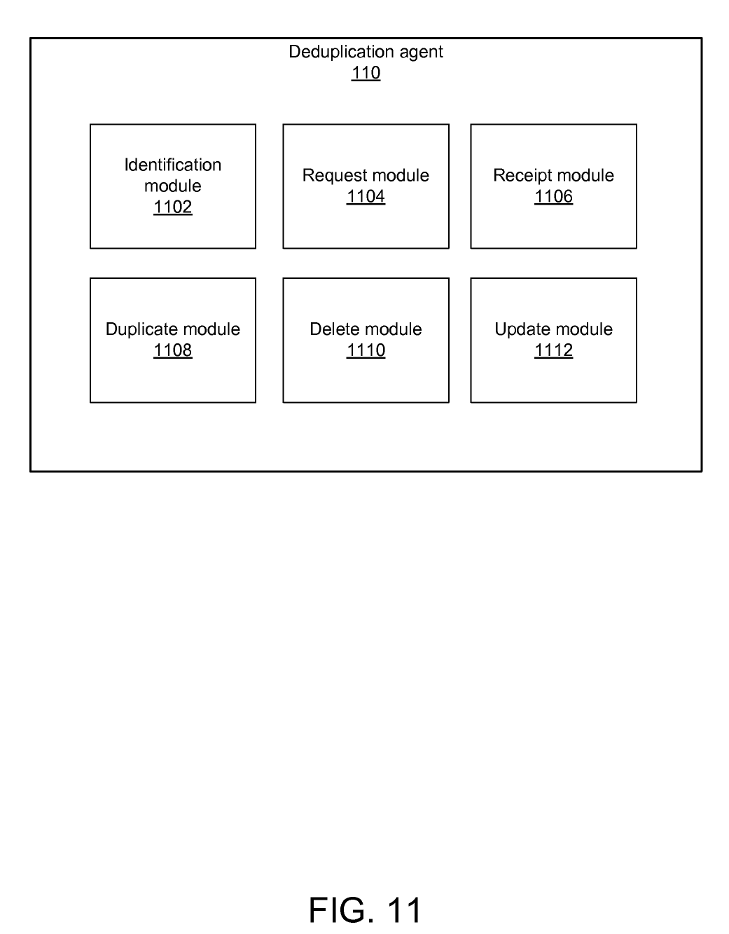

FIG. 11 shows one embodiment of a deduplication agent 110 that includes an identification module 1102, a request module 1104, a receipt module 1106, a deduplication module 1108, a delete module 1110, and an update module 1112. In one embodiment, the deduplication agent 110 is implemented as part of a file system operating on a computing system that is separate from and communicatively connected to the nonvolatile storage device storing, and is separate from and communicatively connected to one or more remote computing devices. The deduplication agent 110 may also be implemented on a nonvolatile storage device.

The identification module 1102 identifies data units to be deduplicated within a storage system that includes one or more nonvolatile storage devices. In certain embodiments, the identification module 1102 coordinates the generation of hashes on the one or more remote computing devices by, for example, tracking which data units that are written to the nonvolatile storage devices and which data units have and have not been deduplicated. In one embodiment, the identification module 1102 flags data units stored in the storage system when the data units are deduplicated. In other embodiments, the nonvolatile storage devices track which data units have and have not been deduplicated. In other embodiments, the remote computing devices that send data units to be stored generate hashes for each data unit that they request to be stored; in such an embodiment, it may be unnecessary to track which data units have and have not been deduplicated.

The request module 1104 sends hash requests, which specify particular data units for which a hash is required, to nonvolatile storage devices in the storage system. Such an embodiment may be described as a “pull” configuration where the deduplication agent 110 requests (pulls) the hashes from the remote computing devices. The hash requests, as discussed above, include a data unit identifier that identifies the data unit for which the hash is requested. In certain embodiments, the request module 1104 may request that the data unit be sent along with the hash of the data unit.

In certain embodiments, the deduplication agent 110 does not request hashes for data units, and simply receives hashes generated by remote computing devices within the storage system. Such an embodiment may be described as a “push” configuration, where the deduplication agent 110 receives the hashes without requesting them. The remote computing devices may be, for example, nonvolatile storage devices, client devices requesting that the data units be stored, or network devices such as bridges, routers, switches, or other network devices.

In certain embodiments, the request module 1104 sends a seed associated with the data unit to remote computing devices (such as nonvolatile storage devices, client devices, or others) that generate the hash of the data unit using the seed. The seed may be sent along with a hash request; in other embodiments, another entity generates the hash request and the request module 1104 simply provides the seed. For example, in FIG. 4, the request module 1104 of the deduplication agent 110 may send the seeds to the nonvolatile storage devices 210a-c.

The receipt module 1106 receives the hash of the data unit from the remote computing device that generated the hash for the data unit; thus, the deduplication agent 110 does not generate the hash and simply receives the hash. As a result, the deduplication agent 110 does not need to touch the data unit in order to determine whether the data unit is a duplicated of an existing data unit.

The duplicate module 1108 determines whether the data unit is a duplicate of an existing data unit that is already stored in the storage system using the hash generated by the remote computing device and received by the receipt module 1106. In one embodiment, the duplicate module 1108 maintains a table of hashes for data units stored within the storage system and compares the hash received by the receipt module 1106 with hashes for other data units as stored in the table. The duplicate module 1108 may also use other data structures and other data (such as data unit metadata) to facilitate determining whether or not the data unit is a duplicate. In certain embodiments, the deduplication agent 110 receives the data unit metadata along with the hash of the data unit.

The delete module 1100 causes the nonvolatile storage devices in the storage system to maintain a single logical copy of the data unit in the storage system. The single logical copy may be the data unit to be stored, or it may be the existing data unit. In one embodiment, the delete module 1100 sends a request to delete the data unit if it determines that the data unit is a duplicate of an existing data unit stored in the storage system. The delete request may be sent to the remote computing device holding the data unit.

In certain embodiments, the delete module 1110 can use information about the existing data unit and the newly received version of the data unit in making decisions about which data unit to delete. For example, in one embodiment, the delete module 1110 communicates with the groomer module 820 to determine which of the data units to delete, and which to keep in storage. For example, the delete module 1110 may use information concerning how many reads, writes, the presence or absence of the existing data unit in the cache, where the data unit is stored in various tiers of storage media in the storage system, the error rate in the area where the existing data unit is stored, and other parameters to determine which data unit to delete. In one embodiment, the delete module 1110 uses information concerning the RAID environment to determine whether to keep the existing copy or the new copy.

Thus, the storage system maintains only a single logical copy of the data unit (such as a file) in it. It should be noted that there may be multiple physical copies within the storage system—for example, when data units are read or operated on, there may be multiple physical copies of the data unit in the storage system (such as in the nonvolatile storage device, RAM, etc) that are inherent in such operations. In addition, there may be multiple physical copies of the data unit to provide redundancy and failure protection. For example, the storage system may have mirrored storage; thus, it maintains a single logical copy but has a corresponding physical copy and another physical copy in redundant storage. In short, in the system described above, there is planned redundancy that is used to provide data protection, but it avoids unplanned redundancy that unnecessarily uses system resources such as storage space.

Similarly, when a data unit is found to be a duplicate, deduplication may include removing the multiple physical copies that constitute the single logical data unit. For example, if a particular file is a duplicate, then the deduplication process may include removing that file from a SAN, from a cache for the SAN, from backing storage, and other locations. Similarly, the deduplication process may include making appropriate changes to ensure that requests for any of those physical copies of the data unit are redirected to the copies of the data unit that is kept.

In one embodiment, the delete module 1100 instructs the nonvolatile storage device to delete the data unit for which the hash was requested, and which was determined to be a duplicate of an existing data unit. In other embodiments, the delete module 1100 instructs the nonvolatile storage device to delete the existing data unit.

The deduplication agent 110 may further be configured with the ability to manage synchronization and locking in connection with the data unit. For example, where multiple clients are using the same data unit simultaneously, the deduplication agent 110 may need to ensure that the data unit is not corrupted. Part of that process may involve making intelligent decisions concerning when the data unit is no longer a duplicate; i.e., when one client has made changes to the data unit that make it distinct from the data unit as used by the other client. In addition, the deduplication agent 110 may also make intelligent decisions about handling the caching of the data unit when multiple clients are accessing it independently. Those skilled in the art will appreciate various ways in which synchronization and locking issues may be addressed.

The update module 1112 associates the data unit with the existing data unit if the data unit is determined to be a duplicate of a data unit existing in the storage system. In one embodiment, the update module 1112 makes changes to an index such that requests for both the data unit and the existing data unit are forwarded to the same data unit. For example, a client may request the data unit that was determined to be a duplicate of an existing data unit and which was thus deleted from the storage system. The update module 1112 may update the index such that the deduplication agent 110, upon intercepting the request, redirects the request away from the deleted data unit and to the identical data unit. In this manner the deduplication agent 110 may remove duplicate data units from the system in a manner transparent to clients that request those data units.

In one embodiment, the update module 1112 also maintains the hash table and adds the hash of the data unit to the hash table if the duplicate module 1108 determines that the data unit is not a duplicate of a data unit already stored in the storage system.

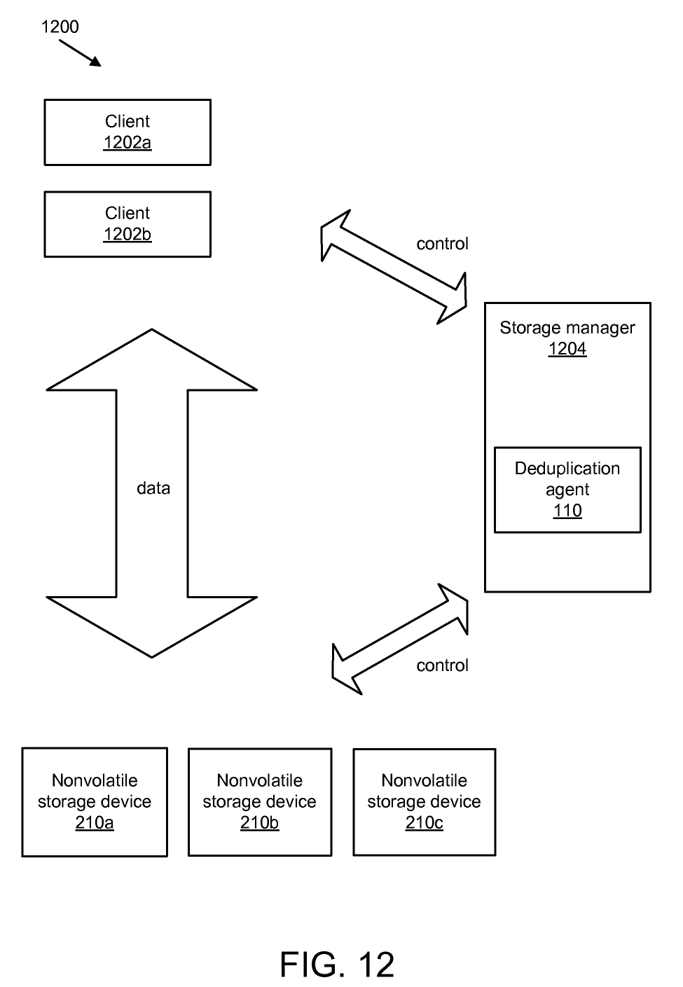

FIG. 12 shows one embodiment of a system 1200 that includes clients 1202a-b, a storage manager 1204, and nonvolatile storage devices 210a-c. The clients 1202a-b, storage manager 1204, and nonvolatile storage devices 210a-c may be connected by a bus or a network. In one embodiment, these components are connected by a SAN. The clients 1202a-b may be individual computer workstations, computer servers, server blades, CPU cores, or other virtual and/or physical computing devices that store and retrieve data from nonvolatile storage devices 210a-c. The system 1200 may be embodied as a laptop, desktop, blade server, cluster, or other computing environment, and may implement direct attached storage (DAS), NAS, SAN, storage class memory (SCM), or other storage solution. The storage manager 1204 manages a control path between the clients 1202a-b and the nonvolatile storage devices 210a-c. In one embodiment, the storage manager 1204 includes a file server, and may also include a deduplication agent 110, as shown in FIG. 12. There may be more, or fewer, of the clients 1202a-b, nonvolatile storage devices 210a-c, and storage managers 1204 than shown in FIG. 12. Similarly, there may be multiple deduplication agents 110 in the system, and the deduplication agents 110 may be distributed across various system components.

In one embodiment, the nonvolatile storage devices 210a-c are block-based storage. In another embodiment, the nonvolatile storage devices 210a-c are object-based storage. The nonvolatile storage devices 210a-c have the capability of generating hashes for specified data units stored therein, as discussed above. In the depicted embodiment, the clients 1202a-b send the data directly to the nonvolatile storage devices 210a-c through a data path that is separate from the control path. Control messages are shared between the clients 1202a-b and the storage manager 1204. Similarly, control messages are shared between the nonvolatile storage devices 210a-c and the storage manager 1204.

In one embodiment, the clients 1202a-b send a control message to the storage manager 1204 when the clients 1202a-b need to write a data unit to the nonvolatile storage devices 210a-c. The storage manager 1204 sends a control message to the nonvolatile storage devices 210a-c in preparation for the write operation. In one embodiment, the control message sent by the storage manager 1204 to the nonvolatile storage device 210a-c includes a hash request.

Once the nonvolatile storage devices 210a-c are prepared to receive the data unit, the clients 1202a-b send the data to the nonvolatile storage devices 210a-c over the data path. The data unit may be sent, in certain embodiments, through a DMA/RDMA operation. In certain embodiments, the nonvolatile storage devices 210a-c store the data unit and generate a hash in response. The nonvolatile storage devices 210a-c may then send an acknowledgment that the data unit was written to the storage manager 1204 using the control path, and send the hash for the data unit along with the acknowledgment.

In a preferred embodiment, the data units are transferred from the clients 1202a-b to the nonvolatile storage devices 210a-c without the deduplication agent 110 touching the data; that is, the deduplication agent 110 does not need to receive and/or make a copy or a near copy of the data units to perform deduplication operations. The deduplication agent 110 receives and generates control messages to support deduplication. The deduplication agent 110 can receive, for example, the hash of the data unit without receiving the data unit itself

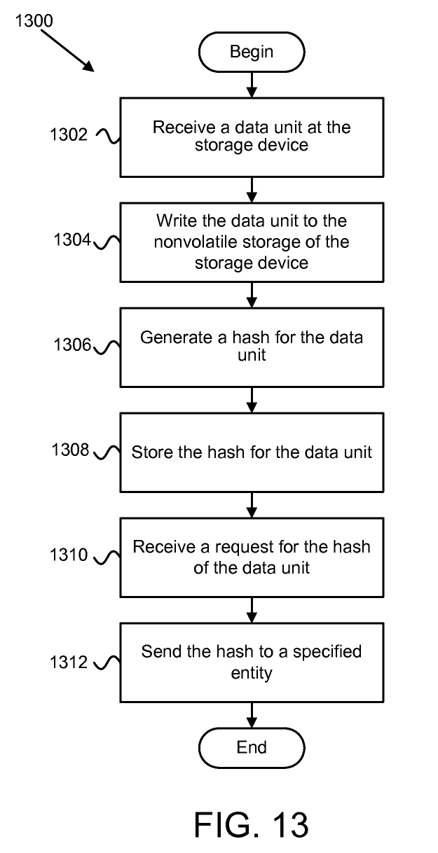

FIG. 13 shows one embodiment of a method 1300 for a nonvolatile storage device, such as the nonvolatile storage device 210a-c, generating a hash for a data unit. While the method 1300 shows one illustrative order in which the method steps may occur, the method steps may be reordered in various implementations. The method 1300 begins with a nonvolatile storage device receiving 1302 a data unit. The nonvolatile storage device writes 1304 the data unit to its nonvolatile storage. The nonvolatile storage may be a hard disk, solid state storage (such as Flash), or other suitable nonvolatile storage. The method 1300 also includes the nonvolatile storage device generating 1306 a hash for the data unit. The hash may be generated as part of the write process, in response to the nonvolatile storage device receiving a hash request from a deduplication agent, as part of a garbage collection process, or other triggering event.

The method 1300 may also include storing 1308 the hash for the data unit. In one embodiment, the nonvolatile storage device stores the hash. In another embodiment, a device physically separate from the nonvolatile storage device but connected by a communications connection (such as a network or a bus) stores the hash. For example, a deduplication agent running on a remote server may store the hash in a hash table.

The method 1300 may also include receiving 1310 a hash request that request the hash of the data unit. As noted above, the hash request also includes a data unit identifier that identifies the data unit for which the hash is requested. The method 1300 may further include sending 1312 the hash to a receiving entity. In one embodiment, the receiving entity is the requesting entity that generated the hash request. In other embodiments, the receiving entity is a different nonvolatile storage device.

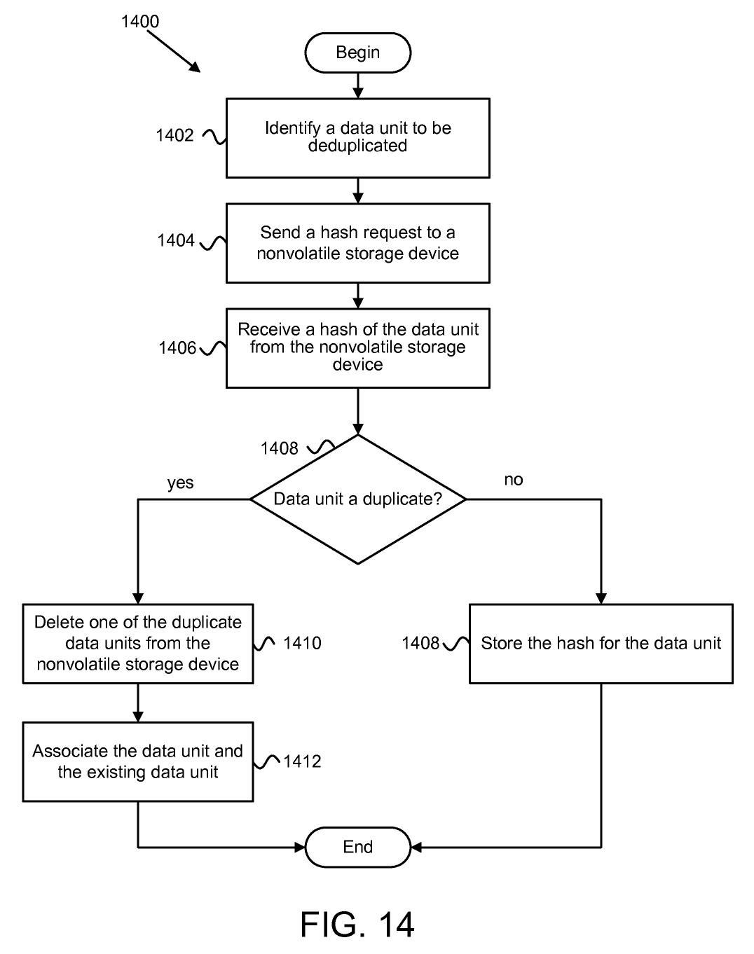

FIG. 14 shows one embodiment of a method 1400 for improved deduplication. In one embodiment, the method is implemented as a computer program on a computer readable medium, which, when executed, performs the steps of the method 1400. In certain embodiments, the method 1400 may include additional steps or fewer steps than those shown. In addition, the order in which the steps of the method 1400 are performed may vary from that shown in FIG. 14.

The method 1400 begins with identifying 1402 a data unit to be deduplicated. In one embodiment, the data unit to be deduplicated is identified by the deduplication agent. In other embodiments, the data unit may be identified by the nonvolatile storage device storing the data unit. In certain embodiments, a flag is used to identify those data units which have been deduplicated and those which have not. The flag may be implemented, for example, in the metadata associated with the data units.

The method 1400 further comprises sending 1404 a hash request to a nonvolatile storage device. In one embodiment, the hash request is sent by the deduplication agent using a control path. The hash request, and the hash itself, may be sent either in band or out of band with the data units themselves. The nonvolatile storage device receives the hash request and transmits the hash. The method 1400 includes receiving 1406 the hash of the data unit sent by the nonvolatile storage device.

With the hash, the method includes determining 1408 whether the data unit is a duplicate of an existing data unit that is stored in the storage system. In one embodiment, the determination is made by comparing the hash with hashes stored in a hash table by a deduplication agent. If an identical hash exists in the hash table, then the data unit is a duplicate of an existing data unit.

If the data unit is not a duplicate of an existing data unit in the storage system, the hash of the data unit is stored 1408 in a data structure for use in making future determinations as to whether or not the data units are duplicates. The hash maybe stored, for example, in a hash table. If the data unit is a duplicate, the method includes deleting 1410 one of the duplicate data units from the storage system. Either the data unit or the existing data unit may be deleted. The method also includes associating 1412 the data unit and the existing data unit. For example, the file system may associate the data unit with the existing data unit through data structures such as tables or indexes. When a request is made to the file system for the deleted data unit, the file system uses data structures associating the deleted data unit with the existing data unit to redirect the request to the existing data unit. Thus, the deduplication operation removes the duplicate data units in a manner that is transparent to the clients requesting the data units.

FIG. 15 shows one embodiment of a storage system 1500 for improved deduplication. The system 1500 includes a client 1202, a network 1512, a nonvolatile storage device 210, and storage 120. In certain embodiments, the system 1500 includes multiple clients 1202 attached to multiple networks 1512 and multiple nonvolatile storage devices 210. The nonvolatile storage device 210 may be a cache for the storage 120, which may be part of a SAN, NAS, SCM, or other storage system. The storage 120 may be, for example, tape backup, hard disk drives, or other nonvolatile storage media. Similarly, the system 1500 may include multiple deduplication agents 110 operating on different computing devices. In such embodiments, the deduplication agents 110 may share information such as hashes, metadata relevant to the deduplication status of various data units, and other information.

As in the other figures, FIG. 15 shows simply one embodiment of a system 1500. In many embodiments, the system 1500 may include more than one client 1202, more than one nonvolatile storage device 210, and more than one storage 120. FIG. 15 is simply one embodiment of a system 1500, and may include more or fewer components than those shown. In addition, the arrangement of devices within the system 1500 may vary. For example, the storage 120 may be directly connected to the network 1512, directly connected to the nonvolatile storage device 210, connected to the nonvolatile storage device 210 through the network 1512, or in some other manner. The same may be true of the connections between the client 1202 and other devices, and the deduplication agent 110 and other devices.

Typically, bandwidth decreases as one moves from the CPU 1502 to the storage 120, while latency increases as one moves from the CPU 1502 to the storage 120. For example, operations at the CPU 1502 can take advantage of high bandwidth and low latency. In contrast, operations performed at the storage 120 must account for the low bandwidth and high latency associated therewith. In addition, generating the hash for a data unit at higher levels (such as in the client 1202) can reduce the amount of traffic on the network 1512 and the bus 1508 that would be occasioned by moving a duplicate data unit.

In the depicted embodiment, the client 1202 includes a CPU 1502, a bridge 1504, SDRAM 1506, a bus 1508, solid state storage 702, a RAID controller 410, and a NIC 1510. The configuration shown, however, is simply one example of a configuration of a client 1202. The client 1202 may include other components, or fewer components, in different implementations. In certain embodiments, the client 1202 may be a virtual computing device.

In one embodiment, the hash generation apparatus 230 is implemented as software stored in computer readable storage media and is executed by the CPU 1502. In certain embodiments, such as a multi-core CPU 1502, execution of the functions of the hash generation apparatus 230 are handled by one of the cores of the CPU 1502. In such an embodiment, the hash generation apparatus 230 may generate hashes for data units that are handled by applications running on the client 1202 and send the hashes to a deduplication agent 110. While the deduplication agent 110 is depicted as being connected to the network 1512, the deduplication agent 110 may be implemented as different locations in the storage system 1500. If the deduplication agent 110 determines that the data unit for which it receives the hash is a duplicate, the CPU 1502 does not cause the data unit to be stored to the nonvolatile storage device 210 or the storage 120. An implementation with the hash generation apparatus 230 at the CPU 1502 may reduce the traffic on the bus 1508 and the network 1512 by performing deduplication on data units without having to move the data unit across the bus 1508 and the network 1512.

In other implementations, the hash generation apparatus 230 may be implemented as hardware on the bridge 1504, the bus 1508, the NIC 1510, or other components on the client 1202. For example, the hash generation apparatus 230 may be implemented on the northbridge (also referred to as a memory controller hub or integrated memory controller) of a client 1202. In certain embodiments, the northbridge may be physically incorporated into the CPU 1502. And in certain embodiments, the deduplication agent 110 may also be operating on the client 1202.

The hash generation apparatus 230 may also be implemented as software, firmware, or hardware at various locations in the client 1202. As above, implementing the hash generation apparatus 230, or portions thereof, at the client 1202 may reduce the amount of traffic that is sent over communications connections such as the network 1512. In such embodiments, the data unit may not need to be transferred out of the particular component implementing the hash generation apparatus 230. As a result, the amount of superfluous data moving through the storage system 1500 can be reduced. In addition, the hash may be used as a data integrity field

In certain embodiments, the hash generation apparatus 230 may be implemented on the network 1512 (such as on routers, switches, bridges, or other network components known in the art) or, as described extensively above, on the nonvolatile storage device 210. The hash generation apparatus 230 may be introduced as hardware, firmware, or software at various locations within the storage system 1500.

In certain embodiments, the system 1500 may include multiple hash generation apparatus 230 implemented at various locations within the system such as within the client 1202, the network 1512, the nonvolatile storage device 210, and the storage 120. In such an embodiment, the hash generation apparatus 230 may be utilized to help validate and verify data units as they are moved through the system 1500. In one embodiment, the hash may be stored with the data unit in the storage 120. One or more of the devices in the system 1500 that have a hash generation apparatus 230 may generate the hash for the data unit as it moves through the system and compare the generated hash with the hash as stored with the data unit.

For example, as the data unit and the stored hash move out of the nonvolatile storage device 210 into the network 1512, one or more devices implementing a hash generation apparatus 230 in the network 1512 and that receive a copy of the data unit and the hash as part of the transfer of the data unit may generate a hash for the data unit. The hash generation apparatus may then compare the generated hash with the stored hash to validate the data unit. In certain embodiments, the hash generation apparatus 230 generates an error or interrupt if the hashes do not match, but forwards the data unit and the stored hash if the hashes do match. The process may repeat at various places through the network 1512 and also within the client 1202 at various locations such as the NIC 1510, the bus 1504, or other locations.

In certain embodiments, the system 1500 implements a hash passing protocol for enabling communications between the deduplication agents 110 in the system and the hash generation apparatus in the system. The hash passing protocol may be a language, an encapsulation of requests and responses, and may be extensible. In one embodiment, the hash generation apparatus packs the hash according to the hash passing protocol for communication to the deduplication agent 110. The hash generation apparatus then sends the hash package to the deduplication agent 110 which receives the hash package, and unpacks the hash. The deduplication agent 110 may then use the hash to determine whether the particular data unit is a duplicate.

Similarly, the hash generation apparatus may communicate with peer hash generation apparatus using the protocol. As discussed above, the hash generation apparatus may communication information such as seeds with peers. In one embodiment, the hash generation apparatus sending the seed packs the seed and sends it according to the hash passing protocol. The protocol may allow the hash generation apparatus to uniquely identify the seed as such to the peer. Other relevant information may also be communicated to the peers using the hash passing protocol.

In one embodiment, the hash passing protocol provides a discovery routine which allows a hash generation apparatus to discover its peers and the deduplication agent 110. In other embodiments, the administrator may provide information on the location of the deduplication agent 110 and the peers along with connection information. Various approaches may be used to initialize communications between the components of the hash generation apparatus/deduplication apparatus system.

In one embodiment, the hash passing protocol provides an Application Programming Interface (API) which dictates the manner in which information is exchanged between components using the hash passing protocol. The API may also provide methods and routines which may be invoked to facilitate deduplication and hash generation.

The hash passing protocol allows the components of the hash generation system, such as multiple hash generation apparatus and deduplication agents 110, to be widely distributed, redundant, and flexible in terms of location. The hash passing protocol may provides the needed functionality which gives a system administrator or system designer flexibility in positioning the hash generation apparatus and the deduplication agents 110 in the system.

The invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for generating, in a nonvolatile storage device, a hash of a data unit that is stored in the nonvolatile storage device, the apparatus comprising:
an input module that is implemented on a nonvolatile storage device and that receives a hash request from a requesting entity, the hash request comprising a data unit identifier that identifies the data unit for which the hash is requested;
wherein the data unit identified by the data unit identifier is stored in the nonvolatile storage device, the nonvolatile storage device comprising a storage controller and a nonvolatile storage connected by a first communications connection, the nonvolatile storage device configured to connect to one or more external devices through a second communications connection that is separate from the first communications connection;
a hash module that is implemented on the nonvolatile storage device and that generates, within the nonvolatile storage device, a hash for the data unit identified by the data unit identifier;
wherein the hash identifies the data unit for which the hash is generated; and
a transmission module that is implemented on the nonvolatile storage device and that sends the hash to a receiving entity over the second communications connection.

2. The apparatus of claim 1, wherein the data unit identifier is one of:
a data unit label that references one or more data unit locations in which the data unit is stored on the nonvolatile storage device, wherein the nonvolatile storage device comprises one or more data structures associating the data unit label and the one or more data unit locations; and
a data structure comprising one or more data unit locations that identify one or more locations on the nonvolatile data storage device where the data unit for which the hash is requested is stored.

3. The apparatus of claim 2, wherein the data unit label is one of a filename, an object ID, and an i-node, and wherein the one or more data unit locations are one of a logical block address and a physical address.

4. The apparatus of claim 1, wherein the hash module generates the hash for the data unit in response to the input module receiving the hash request from the requesting entity.

5. The apparatus of claim 1, wherein the hash request is part of a request to write the data unit.

6. The apparatus of claim 1, wherein the transmission module sends the hash as part of an acknowledgment that the data unit has been successfully written to the nonvolatile storage device.

7. The apparatus of claim 1, wherein the nonvolatile storage device is part of a RAIDed system comprising a plurality of nonvolatile storage devices, and wherein the data unit is a data segment of a RAID data stripe generated for a RAID data block.

8. The apparatus of claim 7, further comprising a seed module that:
receives a seed for generating the hash; and
provides the seed to the hash module, the hash module using the seed to generate the hash in response to receiving the seed from the seed module.

9. The apparatus of claim 8, wherein the seed is a hash of a first data segment of the RAID data stripe, and wherein the hash module uses the seed to generate a hash of a second data segment of the RAID data stripe.

10. The apparatus of claim 9, wherein the receiving entity is a second nonvolatile storage device having a second data segment of the RAID data stripe, and wherein the hash is the seed for the second data segment.

11. The apparatus of claim 7, wherein the nonvolatile storage device is a parity-mirror nonvolatile storage device that locally stores each data segment of the RAID data stripe, the hash module of the parity-mirror nonvolatile storage device generating the hash of the RAID data stripe in conjunction with an operation to generate a parity segment for the RAID data stripe, wherein the hash module uses the locally stored data segments to generate the hash.

12. The apparatus of claim 1, wherein the requesting entity sends the hash request in response to determining that the data unit is moving down at least one level in a cache.

13. The apparatus of claim 1, wherein the requesting entity sends the hash request in response to determining that the data unit is the target of a data grooming operation and that the data unit has not been deduplicated.

14. The apparatus of claim 13, wherein the data grooming operation is one of a garbage collection operation, a defragmentation operation, and a refresh operation.

15. The apparatus of claim 1, wherein the receiving entity is one of the requesting entity and a second nonvolatile storage device.

16. The apparatus of claim 1, wherein the requesting entity is one of internal to the nonvolatile storage device and external to the nonvolatile storage device.

17. An apparatus to perform operations for improved deduplication on a computing device, the apparatus comprising:
a receipt module for receiving a hash of a data unit from one or more remote computing devices that are connected to the computing device by a network, wherein the one or more remote computing devices generate the hash of the data unit and transmit the hash over the network;
a duplicate module for determining, without touching the data unit, whether the data unit is a duplicate of an existing data unit in a storage system, wherein the determination is made using the hash provided by the one or more remote computing devices;
a delete module for causing one or more nonvolatile storage devices in the storage system to maintain a single logical copy that is one of the data unit and the existing data unit in the storage system; and
an update module for associating the data unit with the existing data unit in response to determining that the data unit is a duplicate of the existing data unit such that requests for the data unit and the existing data unit are directed to the logical copy of the data unit stored in the storage system.

18. The apparatus of claim 17, further comprising coordinating the generation of hashes on the one or more remote computing devices.

19. The apparatus of claim 17, further comprising at least one of: a request module for sending a hash request that requests the hash of the data unit to one or more remote computing devices and that comprises a data unit identifier; and the receipt module receiving the hash of the data unit from one or more remote computing devices without requesting the hash from the one or more remote computing devices.

20. The computer program product of claim 17, wherein the apparatus is part of a file system operating on the computing device that comprises a processor and memory.

21. The computer program product of claim 17, the request module further configured to send a seed associated with the data unit to the one or more remote computing devices, the one or more remote computing devices generating the hash of the data unit using the seed.

22. The apparatus of claim 17, wherein the one or more remote computing devices are client devices and wherein the hash is generated in one of a CPU, a bridge, a bus, a controller, a memory, and a network interface card (NIC) of the remote client devices.

23. A system for improved deduplication, the system comprising:
a deduplication agent that determines whether a data unit is a duplicate of an existing data unit in a storage system comprising one or more nonvolatile storage devices by using a hash of the data unit, the deduplication agent operating on a first computing device;
a hash generation apparatus for generating the hash of the data unit, the hash generation apparatus operating on a second computing device remote from the first computing device and connected to the first computing device by a communications connection, the hash generation apparatus comprising:
an input module that receives a hash request from a requesting entity, the hash request comprising a data unit identifier that identifies the data unit for which the hash is requested;
a hash module that generates a hash for the data unit identified by the data unit identifier, wherein the hash identifies the data unit for which the hash is generated; and
a transmission module that sends the hash to a receiving entity in response to the input module receiving the hash request.

24. The system of claim 23, wherein the nonvolatile storage devices are configured as a RAIDed system, wherein the data unit is a data segment of a RAID data stripe generated for a RAID data block.

25. They system of claim 24, wherein the hash generation apparatus further comprises a seed module that:
receives a seed for generating the hash; and
provides the seed to the hash module, the hash module using the seed to generate the hash for the data stripe in response to receiving the seed from the seed module.

26. The system of claim 23, wherein the requesting entity is the deduplication agent.

27. The system of claim 23, wherein the first computing device is one of a nonvolatile storage device, a network device, a network interface card (NIC), a RAID controller, a bridge, and a bus, and wherein the second computing device is one of a nonvolatile storage device, a network device, a network interface card (NIC), a RAID controller, a bridge, and a bus.

28. The system of claim 23, wherein hash generation apparatus communicates with the deduplication agent using a hash passing protocol.

29. The system of claim 23, further comprising one or more additional hash generation apparatuses, and wherein the hash generation apparatus of each device that touches the data unit during data storage and data retrieval operations generates a hash for data protection.
